(19) United States
(12) Patent Application Publication
(10) Pub. No.: US 2009/0240634 A1
(43) Pub. Date: Sep. 24, 2009

(54) Systems and Methods for Automating Calculation of Costs Associated with an Application Packaging Job

(75) Inventors: John Mullin, Edinburgh (GB); Thomas Elliot, Edinburgh (GB); Damian Dwyer, Hamilton (GB); Ian Porter, Giffnock (GB); Nilakantha Ratha, Edinburgh (GB); Iain Glennie, Isle of Lewis (GB); Gordon Davey, Greenock (GB)

Correspondence Address: BAKER BOTTS L. L. P., One Shell Plaza, 910 Louisiana, Houston, TX, 77002-4995, US

(73) Assignee: DELL PRODUCTS L. P., Round Rock, TX (US)

(21) Appl. No.: 12/052,960

(22) Filed: Mar. 21, 2008

(51) Int. Cl. G06Q 10/00

(52) U.S. Cl. 705/400

(57) ABSTRACT

A system and method for generating a configurable workflow for application packaging jobs are disclosed. A method may include receiving input from a user interface by a packaging application configured to manage an application packaging job. The method may also include creating a plurality of workflow states based on at least the received input, each workflow state associated with a particular step in the application packaging job. The method may further include associating at least one action with at least one workflow state based on at least the received input, each action defining a transition from its associated workflow state to a target workflow state. Additionally, the method may include associating an assignee type with at least one action based on at least the received input, the assignee type defining at least one assignee that may assigned to the application packaging job for the particular action.

### TECHNICAL FIELD

The present disclosure relates in general to application packaging, and more particularly to systems and methods for generating a configurable workflow for application packaging jobs.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often employ application programs (also known as application software) to expand their functionality. Application programs may be thought of as a subclass of computer software that employs the capabilities of a computer to perform a task that the user wishes to perform. Application programs may be contrasted with system software which is involved in integrating a computer's various capabilities, but typically does not directly apply them to perform tasks that benefit the user. In this context the term application refers to both the application program and its implementation. Some examples of application programs might include word processors, spreadsheets, web browsers, and media players.

Application programs are often developed by software programmers. When development of an application is completed by software programmers, considerable work may still be required to enable deployment of the application on a user's computer. This is often because users of application programs may expect an easy-to-use, complete setup solution (e.g., a file or collection of files that may be installed and configured by means of Windows installer). Often, such setup solutions include updates to and removal or uninstallation of the application program.

The process of creating an installation package may be complex. For example, a modern application (e.g., Microsoft Word, Microsoft Excel, or Microsoft Visual Studio) may comprise hundreds or thousands of file folders and thousands or tens of thousands of files. Additionally, in large organizations, which often have many third-party and in-house applications, important dependencies may exist between applications and their installation packages. Tracking and resolving such dependencies can be a daunting task.

Accordingly, systems and methods that control and/or track the application packaging process, starting with a customer's initial request, through engineering, quality assurance, and so on through the deployment of an application program are desired.

### SUMMARY

In accordance with the teachings of the present disclosure, disadvantages and problems associated with the packaging of an application program may be substantially reduced or eliminated.

In accordance with one embodiment of the present disclosure, a method for generating a configurable workflow for application packaging, is provided. The method may include receiving input from a user interface by a packaging application configured to manage an application packaging job. The method may also include creating a plurality of workflow states based on at least the received input, each workflow state associated with a particular step in the application packaging job. The method may further include associating at least one action with at least one workflow state based on at least the received input, each action defining a transition from its associated workflow state to a target workflow state. Additionally, the method may include associating an assignee type with at least one action based on at least the received input, the assignee type defining at least one assignee that may assigned to the application packaging job for the particular action.

In accordance with another embodiment of the present disclosure, an information handling system, may include a processor, a memory coupled to the processor, and a tangible-computer-readable medium communicatively coupled to the processor. The tangible computer-readable medium have stored thereon a program of instructions. The program of instructions may be operable to, when executed by the processor: (a) receive input from a user interface; (b) create a plurality of workflow states based on at least input from a user based on at least the received input, each workflow state associated with a particular step in the application packaging job; (c) associate at least one action with at least one workflow state based on at least input from the user based on at least the received input, each action defining a transition from its associated workflow state to a target workflow state; and (d) associate an assignee type with at least one action based on at least input from the user based on at least the received input, the assignee type defining at least one assignee that may assigned to the application packaging job for the particular action.

In accordance with an additional embodiment of the present disclosure, a program of instructions may be embodied on a computer-readable medium. The program of instructions operable to, when executed: (a) receive input from a user interface; (b) create a plurality of workflow states based on at least input from a user based on at least the received input, each workflow state associated with a particular step in the application packaging job; (c) associate at least one action with at least one workflow state based on at least input from the user based on at least the received input, each action defining a transition from its associated workflow state to a target workflow state; and (d) associate an assignee type with at least one action based on at least input from the user based on at least the received input, the assignee type defining at least one assignee that may assigned to the application packaging job for the particular action.

In accordance with a further embodiment of the present disclosure, a method for automating tasks associated with an application packaging job may be provided. The method may include receiving from a user interface a request to transition from a first workflow state to a second workflow state based on at least the received input, each of the first workflow state and second workflow state associated with a respective step in an application packaging job. The method may also include storing in a queue information associated with a script by the packaging application in response to request to transition from the first workflow state to the second workflow state, the script including instructions for performing an automated task related to the application packaging job. Additionally, the method may include monitoring the queue for pending scripts by a script agent running a process separate from the packaging application. The method may further include executing the script by the script agent.

In accordance with yet another embodiment of the present disclosure, a system for automating tasks associated with an application packaging job may include a database, a packaging application communicatively coupled to the database, and a script agent running a process separate from the packaging application and communicatively coupled to the database and the packaging application. The database may be configured to store a script including instructions for performing an automated task related to an application packaging job. The packaging application may be configured to (a) manage the application packaging job, (b) receive from a user interface a request to transition from a first workflow state to a second workflow state based on at least the received input, each of the first workflow state and second workflow state associated with a respective step in the application packaging job; and (c) store information associated with the script in a queue in response to receiving the request to transition from the first workflow state to the second workflow state. The script agent may be configured to monitor the queue for pending scripts and execute the script.

In accordance with yet another embodiment of the present disclosure, an information handling system may include a processor, a memory communicatively coupled to the processor, and a tangible computer-readable medium communicatively coupled to the processor. The tangible computer-readable medium may have stored thereon a database, a packaging application communicatively coupled to the database, and a script agent operable to, when executed by the processor, run a process separate from the packaging application. The database may be configured to store a script including instructions for performing an automated task related to an application packaging job. The packaging may be configured to (a) manage the application packaging job; (b) receive from a user interface a request to transition from a first workflow state to a second workflow state based on at least the received input, each of the first workflow state and second workflow state associated with a respective step in the application packaging job; and (c) store information associated with the script in a queue in response to receiving the request to transition from the first workflow state to the second workflow state. The script agent may be configured to monitor the queue for pending scripts, read the script from the database, and execute the script.

In accordance with yet another embodiment of the present disclosure, a method for automating calculation of costs associated with an application packaging job may be provided. The method may include receiving input from a user interface by a packaging application configured to manage an application packaging job. The method may also include creating a plurality of workflow states based on at least the received input, each workflow state associated with a particular step in the application packaging job. Additionally, the method may include associating a cost schedule with at least one of the workflow states, wherein the cost schedule is based on one of an hourly rate for completion of the state and a complexity associated with the application packaging job. The method may further include calculating the cost associated with the application packaging job based on at least the cost schedule for each of the plurality of workflow states.

In accordance with yet another embodiment of the present disclosure, an information handling system may include a processor, a memory communicatively coupled to the processor, and a tangible computer-readable medium communicatively coupled to the processor. The tangible computer-readable medium may have stored thereon a program of instructions operable to, when executed by the processor: (a) receive input from a user interface; (b) create a plurality of workflow states based on at least input from a user based on at least the received input, each workflow state associated with a particular step in the application packaging job; (c) associate a cost schedule with at least one of the workflow states, wherein the cost schedule is based on one of an hourly rate for completion of the state and a complexity associated with the application packaging job; and (d) calculate the cost associated with the application packaging job based on at least the cost schedule for each of the plurality of workflow states.

In accordance with yet another embodiment of the present disclosure, a program of instructions may be embodied on a tangible computer-readable medium. The program of instructions may be operable to, when executed: (a) receive input from a user interface; (b) create a plurality of workflow states based on at least input from a user based on at least the received input, each workflow state associated with a particular step in the application packaging job; (c) associate a cost schedule with at least one of the workflow states, wherein the cost schedule is based on one of an hourly rate for completion of the state and a complexity associated with the application packaging job; and (d) calculate the cost associated with the application packaging job based on at least the cost schedule for each of the plurality of workflow states.

Various embodiments of the present disclosure may benefit from numerous technical advantages. It should be noted that one or more embodiments may benefit from some, none, or all of the advantages.

At least one embodiment has the technical advantage of processing physical data of a technical process. More specifically, at least one embodiment has the technical advantage of processing data of an application packaging process. The processed and/or generated data may represent a configurable workflow of an application packaging process allowing for the creation of an installation package. The processed and/or generated data may represent tasks associated with an application packaging process allowing for the creation of an installation package. The processed and/or generated data may represent costs associated with an application packaging process allowing for the creation of an installation package.

At least one embodiment may comprise a computer program comprising computer program instructions to program a programmable processing apparatus, such as for example an information handling system, to become operable to perform a method as set out in the above embodiments.

At least one embodiment may comprise a storage medium storing computer program instructions to program a programmable processing apparatus to become operable to perform a method as set out in the above embodiments.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring, by way of example, to the following description taken in conjunction with the accompanying drawings, in which like reference numbers indicate like features, and wherein:

FIG. 1 illustrates a block diagram of an example system for generating and using a configurable workflow for application packaging jobs, in accordance with the present disclosure;

FIGS. 2A and 2B illustrate a flow chart of an example method for generating a configurable workflow for application packaging jobs, in accordance with the present disclosure;

FIGS. 3A-3O illustrate example user interface screens displayed during a method for generating a configurable workflow for application packaging jobs, in accordance with the present disclosure;

FIG. 4 illustrates a state diagram for a portion of an example workflow for an application packaging job generated using the method depicted in FIGS. 2A and 2B, in accordance with the present disclosure;

FIGS. 5A-5X illustrate example user interface screens displayed by a packaging application during the application packaging job depicted in FIG. 4, in accordance with the present disclosure;

FIG. 6 illustrates a flow chart of an example method for automating tasks associated with an application packaging job, in accordance with the present disclosure; and

FIG. 7 illustrates a flow chart of an example method for automating calculating costs associated with an application packaging job, in accordance with the present disclosure.

### DETAILED DESCRIPTION

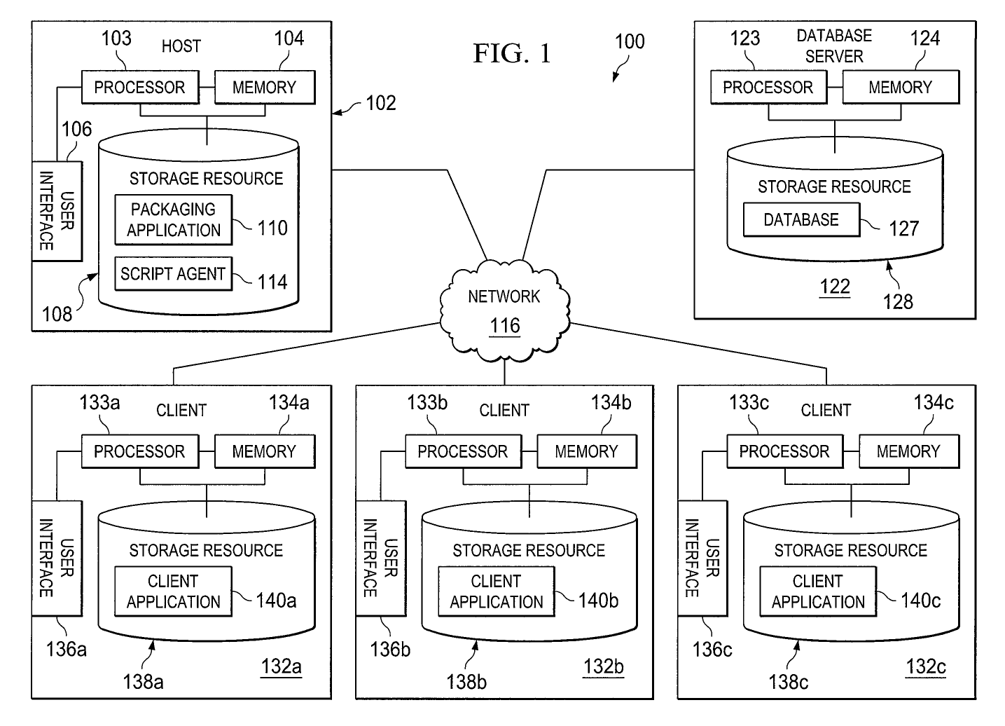

Preferred embodiments and their advantages are best understood by reference to FIGS. 1-7, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage resource, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory, as well as communications media such wires, optical fibers, microwaves, radio waves, and other electromagnetic and/or optical carriers; and/or any combination of the foregoing.

FIG. 1 illustrates a block diagram of an example system 100 for generating and using a configurable workflow for application packaging jobs, in accordance with the present disclosure. As depicted in FIG. 1, system 100 may include host 102, network 116, database server 122, and clients 132a-132c (which may be individually referred to as client 132 or collectively as clients 132).

Host 102 may comprise any suitable type of information handling system(s); in certain embodiments, host 102 may be a server (e.g., a web server). In the same or alternative embodiments, host 102 may comprise a peripheral device, such as a printer, sound card, speakers, monitor, keyboard, pointing device, microphone, scanner, and/or “dummy” terminal, for example. As shown in FIG. 1, host 102 may include a processor 103, a memory 104 communicatively coupled to processor 103, a user interface 106 communicatively coupled to processor 103, and a storage resource 108 communicatively coupled to processor 103 and memory 104.

Processor 103 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource 108, and/or another component of host 102.

Memory 104 may be communicatively coupled to processor 103 and may comprise any system, device, or apparatus operable to retain program instructions or data for a period of time (e.g., computer-readable media). Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to host 102 is turned off.

User interface 106 may be communicatively coupled to processor 103 and may include any instrumentality or aggregation of instrumentalities by which a user may interact with host 102. For example, user interface 106 may permit a user to input data and/or instructions into host 102 (e.g., via a keyboard, pointing device, and/or other suitable means), and/or otherwise manipulate host 102 and its associated components. User interface 106 may also permit host 102 to communicate data to a user, e.g., by means of a display device.

Storage resource 108 may be communicatively coupled to processor 103 and/or memory 104 and may include any system, device, or apparatus operable to retain program instructions or data for a period of time (e.g., computer-readable media) and that retains data after power to host 102 is turned off. Storage resource 108 may include one or more hard disk drives, magnetic tape libraries, optical disk drives, magneto-optical disk drives, compact disk drives, compact disk arrays, disk array controllers, and/or any computer-readable medium operable to store data. As depicted in FIG. 1, storage resource 108 may include a packaging application 110 and a script agent 114. Although FIG. 1 depicts storage resource 108 as internal and local to host 102, storage resource 108 may in certain embodiments be locally attached but external to information handling system 102 (e.g., a USB flash drive and/or an external hard drive). In other embodiments, storage resource 108 may be remote to information handling system 108 (e.g., coupled via network 116).

Packaging application 110 may include a program of instructions operable to, when executed by processor 103, generate workflows for application packaging jobs, as discussed in greater detail below. Packaging application 110 may also be operable to manage application packaging jobs in accordance with such generated workflows, as also described in greater detail below.

For example, packaging application 110 may create one or more workflow states based on input received from a user interface, wherein each workflow state is associated with a particular step in an application packaging job. Packaging application 110 may also associate at least one action with at least one workflow state based on input received from a user interface, each action defining a transition from its associated workflow state to a target workflow state. Packaging application 110 may also associate an assignee type with each action based on input received from a user interface, the assignee type defining at least one assignee that may be assigned to the application packaging job for the action. In certain applications, packaging application 110 may include or may be an integral part of a web server application.

Script agent 114 may include a program of instructions operable, when executed by processor 103, to execute and/or run scripts designated by packaging application 110 and/or a user thereof, as discussed in greater detail below. In certain embodiments, script agent 114 may execute on processor 103 in a process separate from packaging application 110. In the same or alternative embodiments, script agent 114 may be operable to execute scripts written in the C# programming language. Script agent 114 may execute any suitable script related to an application packaging job. For example, script agent 114 may execute a script to create one or more file folders related to an application packaging job, create an installation file for an application packaging job, and/or perform tasks related to the versioning of an application packaging job or file.

Network 116 may include any network and/or fabric configured to communicatively couple host 102, database server 122, and/or clients 132 to one another. In certain embodiments, network 116 may include a communication infrastructure, which provides physical connections, and a management layer, which organizes the physical connections of host 102, database server 122, and/or clients 132. Network 116 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data and/or messages (generally referred to as data). Network 116 may transmit data using any storage and/or communication protocol, including without limitation, Fibre Channel, Frame Relay, Ethernet Asynchronous Transfer Mode (ATM), Internet protocol (IP), or other packet-based protocol, and/or any combination thereof. Network 116 and its various components may be implemented using hardware, software, or any combination thereof. In certain embodiments, one or more of host 102, database server 122, and/or clients 132 may include a network interface card (NIC) which may provide a physical coupling to network 116.

Database server 122 may comprise any suitable type of information handling system(s) and in certain embodiments, database server 122 may be a specialized and/or dedicated server for performing database operations. In the same or alternative embodiments, database server 122 may comprise a peripheral device, such as a printer, sound card, speakers, monitor, keyboard, pointing device, microphone, scanner, and/or “dummy” terminal, for example. As shown in FIG. 1, database server 122 may include a processor 123, a memory 124 communicatively coupled to processor 123, a user interface 126 communicatively coupled to processor 123, and a storage resource 128 communicatively coupled to processor 123 and memory 124. In certain embodiments, one or more of processor 123, memory 124, and storage resource 128 may have characteristics and/or functionality identical or similar to that of processor 103, memory 104, and storage resource 108 of host 102.

As depicted if FIG. 1, storage resource 128 may store a database 127. Database 127 may include information related to generated workflows for application packaging jobs and/or individual application packaging jobs. For example, database 127 may include information regarding one or more workflow states associated with a workflow, one or more actions associated with each workflow state, users and/or assignees associated with each state and/or each action, and/or user interface information associated with the workflow states and/or actions. In addition or alternatively, database 127 may include scripts that may be executed by script agent 114. Furthermore, database 127 may include a queue listing pending scripts to be executed by script agent 114.

Although FIG. 1 depicts database server 122 including database 127, in certain embodiments of system 100, database 127 may be stored on storage resource 108 of host 102. In such embodiments, system 100 may not include a separate database server 122.

Each client 132 may comprise any suitable type of information handling system(s); in certain embodiments, one or more of clients 132 may comprise a personal computer. In the same or alternative embodiments, one or more of clients 132 may comprise a peripheral device, such as a printer, sound card, speakers, monitor, keyboard, pointing device, microphone, scanner, and/or “dummy” terminal, for example. As shown in FIG. 1, each client 132 may include a processor 133, a memory 134 communicatively coupled to processor 133, a user interface 136 communicatively coupled to processor 133, and a storage resource 138 communicatively coupled to processor 133 and memory 134. In certain embodiments, one or more of processor 133, memory 134, and storage resource 138 may have characteristics and/or functionality identical or similar to that of processor 103, memory 104, and storage resource 108 of host 102.

As shown in FIG. 1, storage resource 138 may include a client application 140. Client application 140 may be operable, when executed by processor 133, to interface with packaging application 110 to perform tasks and/or communicate information regarding an application packaging job, as discussed in greater detail below. For example, client application 140 may allow a packaging engineer to interface with packaging application 110 to allow the packaging engineer to view application packaging jobs assigned to the packaging engineer, and enter information regarding the packaging job. Client application 140 may also allow others associated with an application packaging job (e.g., customers requesting a packaging job, quality assurance engineers, managers, etc.) to interface with packaging application 140. In certain embodiments, client application 140 may be a web browser.

Although FIG. 1 depicts system 100 having three clients 132, system 100 may have any suitable number of clients 132. In addition, system 100 may include components other than those depicted in FIG. 1. For example, in some embodiments, system 100 may include one or more mail servers and/or file servers.

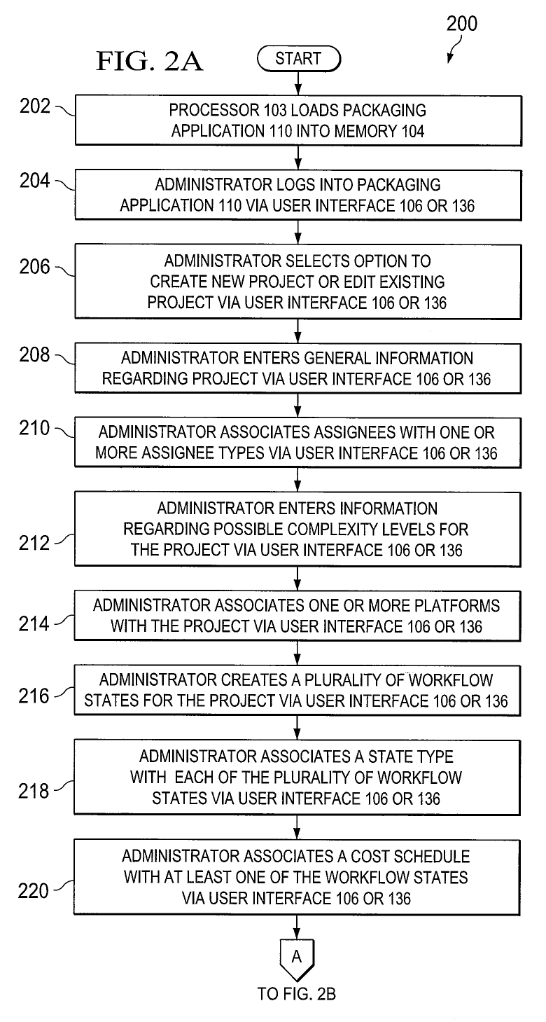

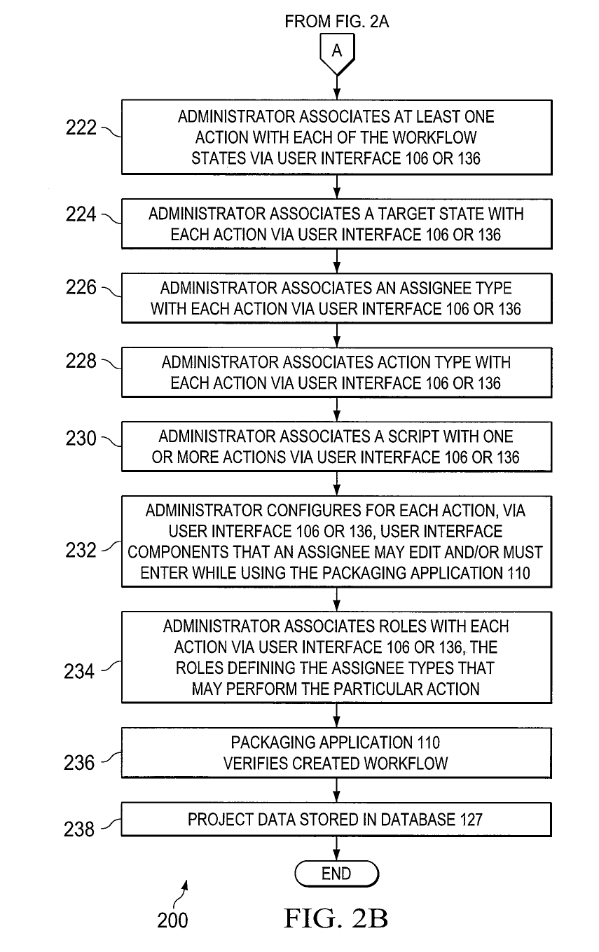

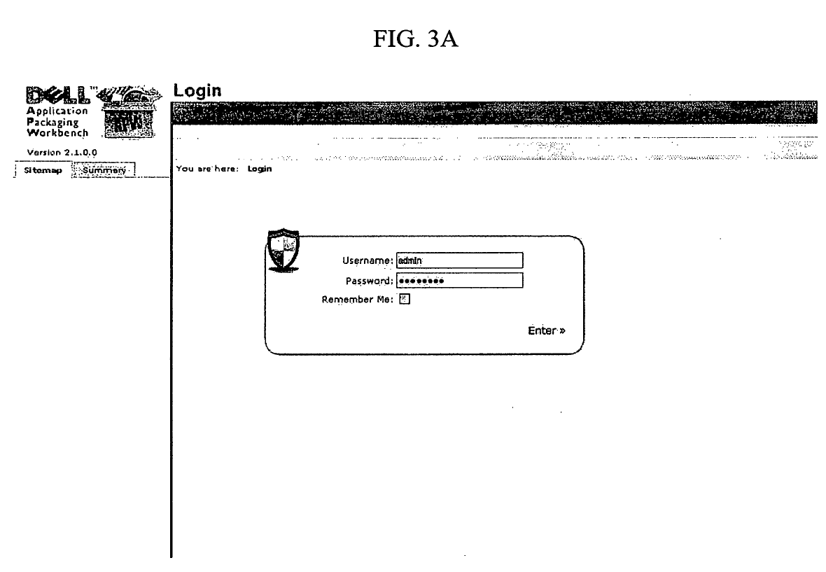

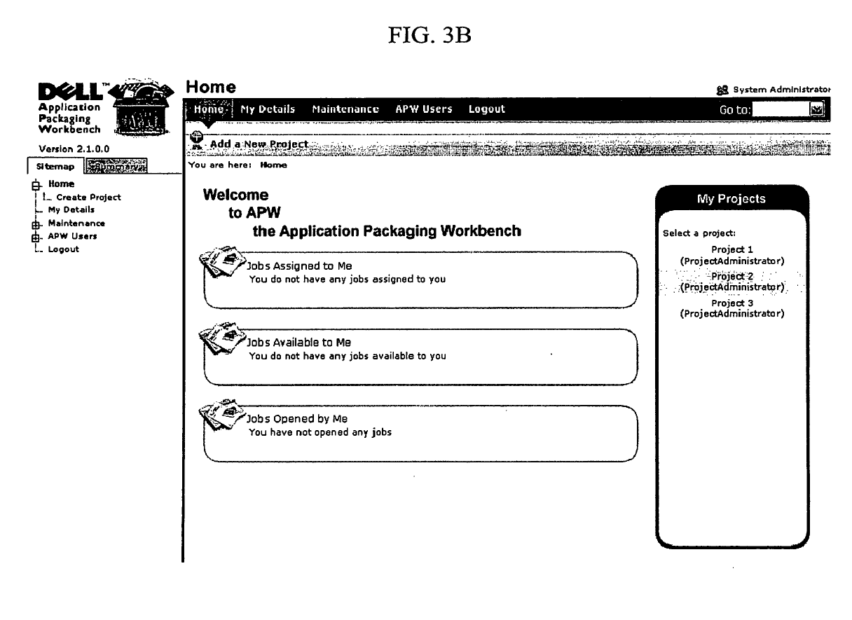

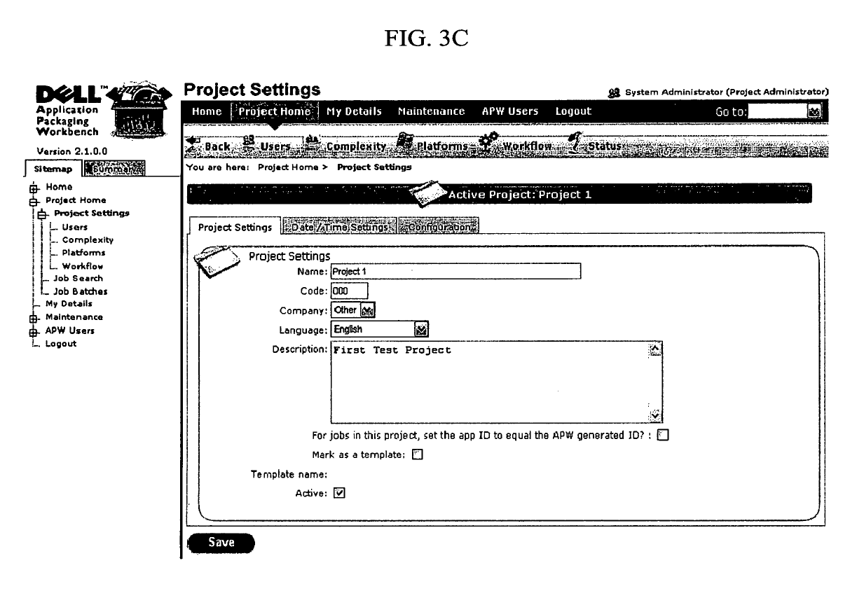

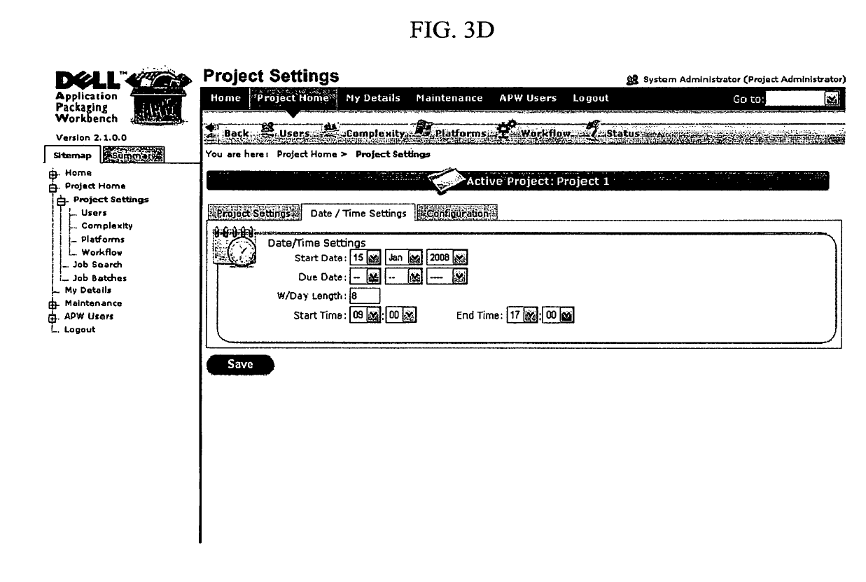

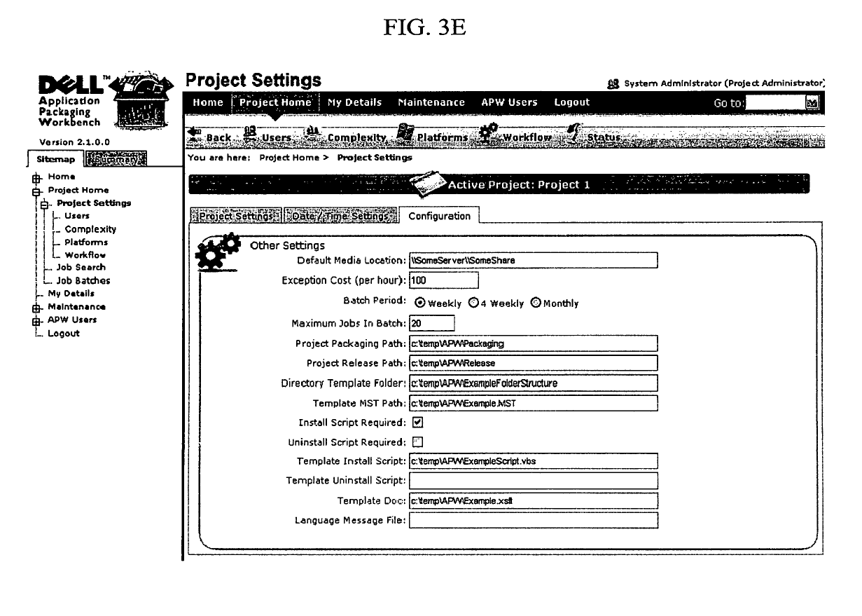

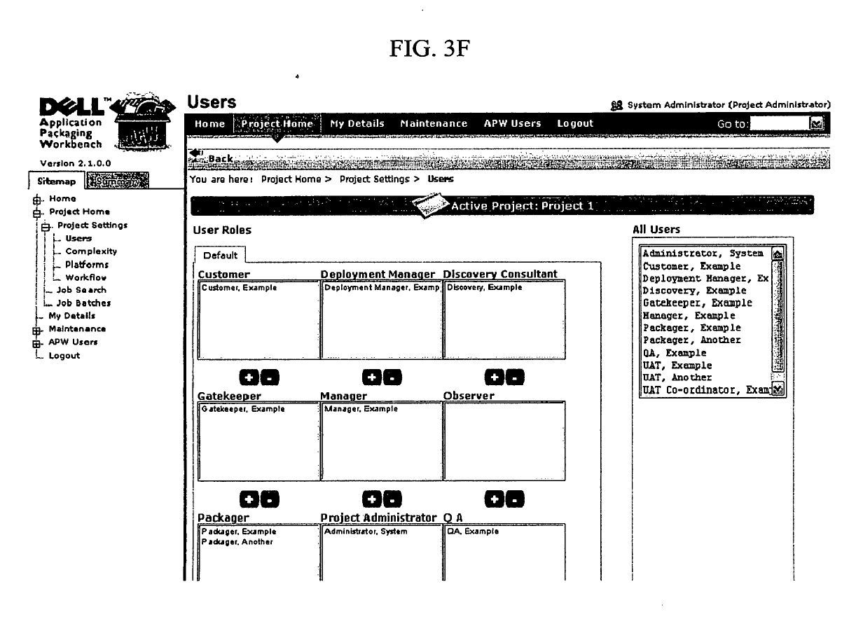

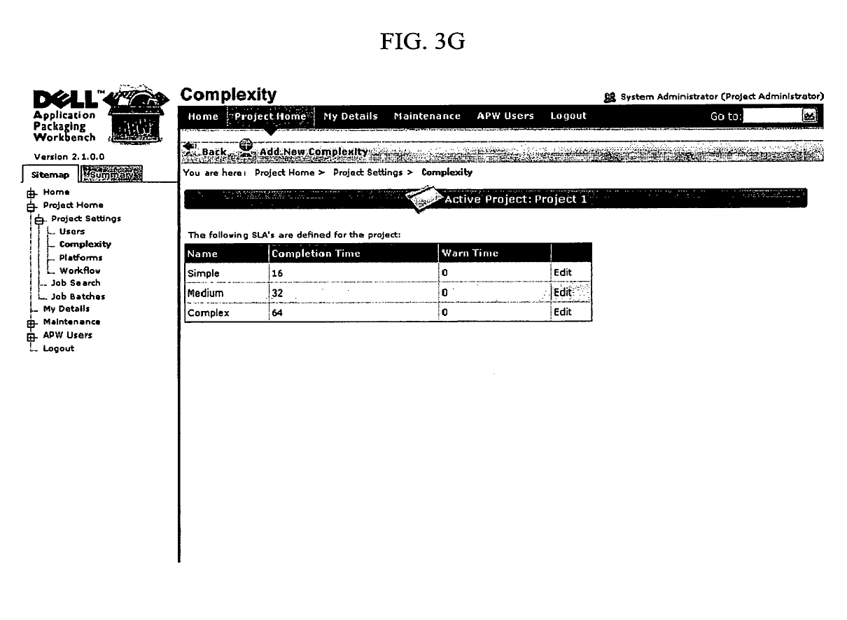

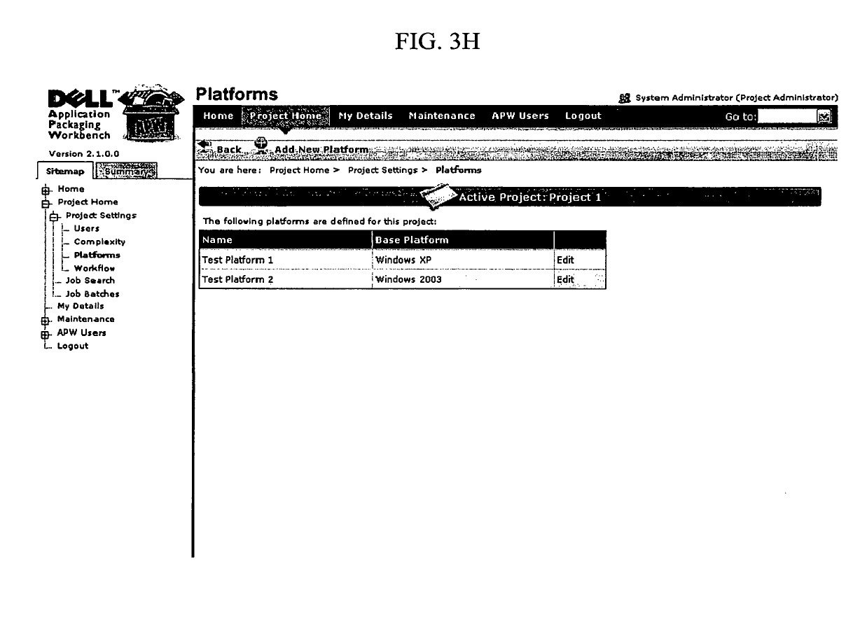

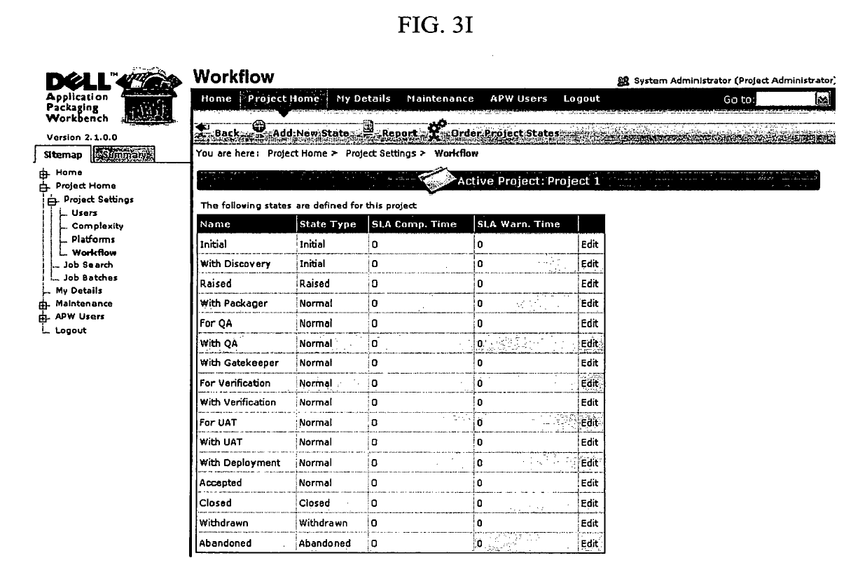

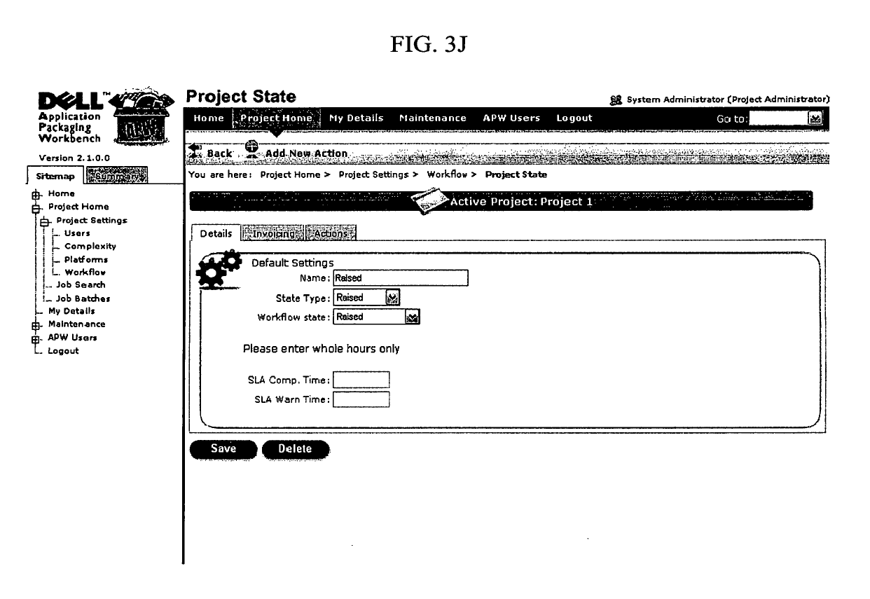

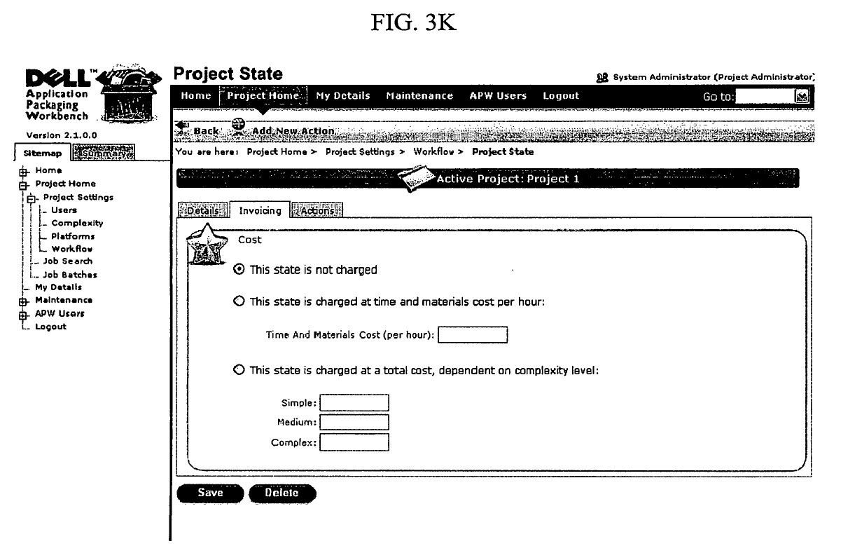

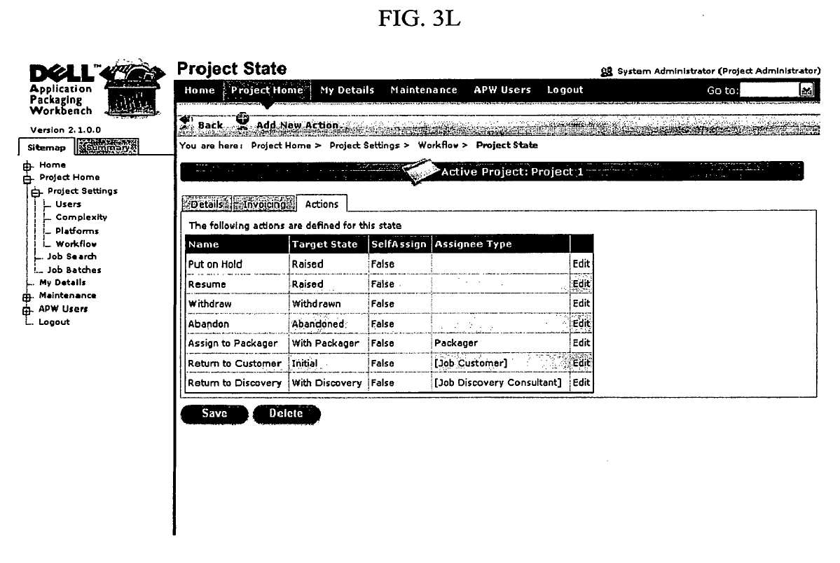

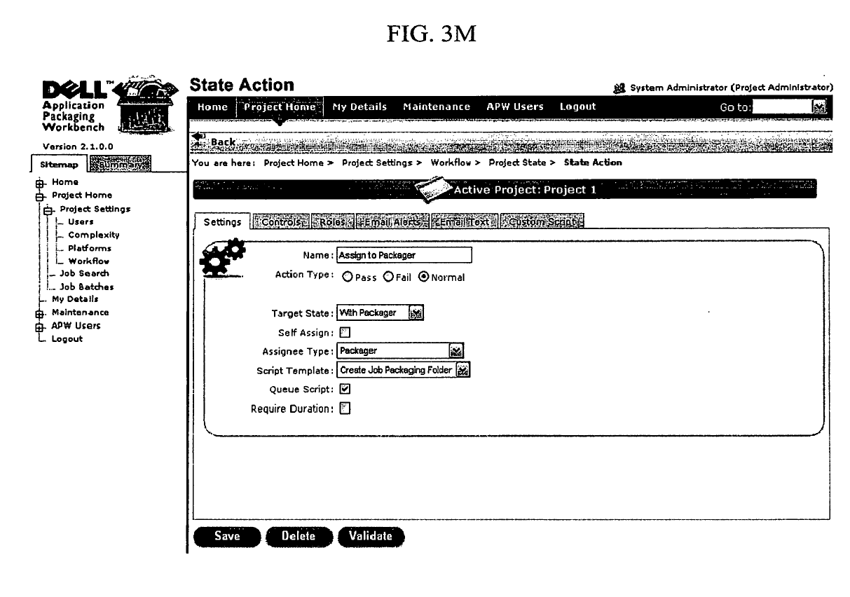

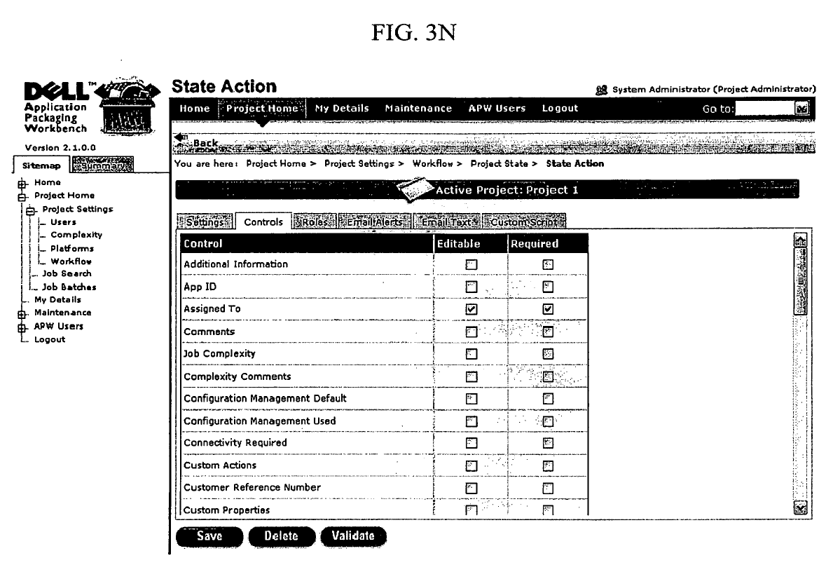

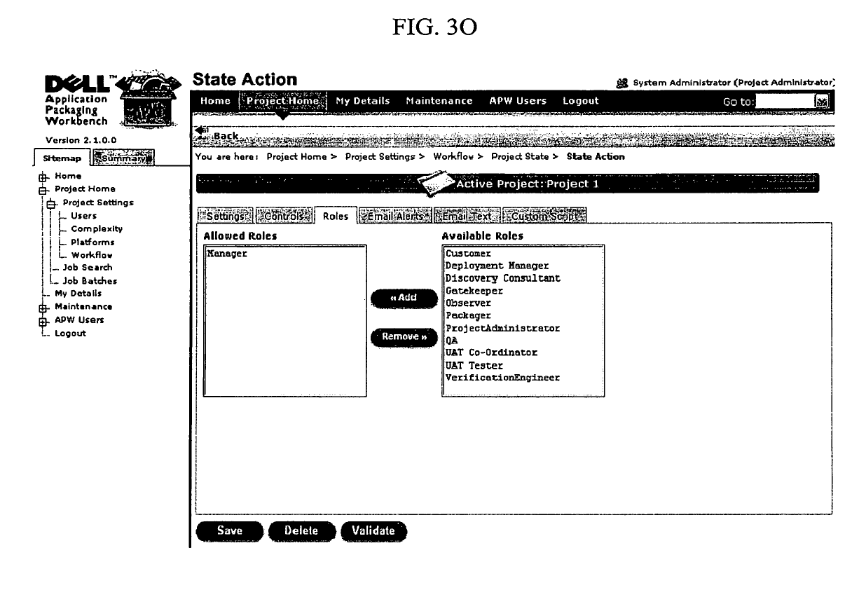

FIGS. 2A and 2B illustrate a flow chart of an example method 200 for generating a configurable workflow for application packaging jobs, in accordance with the present disclosure. FIGS. 3A-3O illustrate example user interface screens displayed during method 200, in accordance with the present disclosure. According to one embodiment, method 200 preferably begins at step 202. As noted above, teachings of the present disclosure may be implemented in a variety of configurations of system 100. As such, the preferred initialization point for method 200 and the order of the steps 202-238 comprising method 200 may depend on the implementation chosen.

At step 202, processor 103 may load packaging application 110 into memory 104 and begin executing packaging application 110. At step 204, an administrator or another user may log into packaging application 110 via user interface 106 of host 102 or a user interface 136 of a client 132, such as depicted in FIG. 3A, for example. After logging in, at step 206, the administrator may select an option to create a new project or edit an existing project via user interface 106 or 136. For example, as shown in FIG. 3B, the administrator may select to open “Project 1” by clicking on the name of the project from a list of projects displayed on a screen. As used herein, a “project” may define a workflow applicable to a set of one or more application packaging jobs. For example, each process may define a series of workflow states for one or more application packaging jobs, wherein each workflow states to respond to a particular step in an application packaging job.

At step 208, the administrator may enter general information regarding the project via user interface 106 or 136. For example, as shown in FIG. 3C, the administrator may enter information regarding the project's name, the company or customer to which the project is applicable, a language applicable for the project, and/or a description of the project. As another example, as shown in FIG. 3D, the administrator may enter information regarding the start date for the project, the due date for the project, the working day length, the working day start time, and/or the working day end time. As a further example, as shown in FIG. 3E, the administrator may enter general configuration information regarding the project (e.g., default media path locations for application packaging jobs, maximum numbers of application packaging jobs that may be performed in a single batch, the frequency of batches, a path for project packaging files, a path for project release files, template file information, template script information, and/or other configuration information).

At step 210, the administrator may associate one or more assignees to one or more assignee types via user interface 106 or 136. For example, as shown in FIG. 3F, a project may include one or more assignee types or user roles to which a particular assignee/user may associated. For example, for the particular project, the administrator may associate a user named “Example Customer” to the “Customer” assignee type. Other possible assignee types/roles may include, for example: Project Manager, Manager, Discovery Consultant, Packager, Quality Assurance, Gatekeeper, Verification Engineer, User Acceptance Testing Coordinator, User Acceptance Testing Tester, and/or Deployment Manager.

At step 212, the administrator may enter information regarding possible complexity levels for the project via user interface 106 or 136. For example, as shown in FIG. 3G, a complexity level of “simple” may have a completion time of about 16 hours, a complexity level of “medium” may have a completion time of about 32 hours, and a complexity level of “complex” may have a completion time of about 64 hours. The complexity levels may be used in whole or part to determine a cost to be invoiced to a customer for a particular project and/or application packaging job, as discussed in greater detail below.

At step 214, the administrator may associate one or more platforms with the project via user interface 106 or 136. As depicted in FIG. 3H, each “platform” may relate to a user-defined build for one or more information handling systems to which an application may be deployed. For example, the content of an installation package created during an application packaging job may depend on the operating system running on the information handling system to which the installation package is to be deployed. Thus, when application packaging jobs are created, the applicable platform may be designated.

At step 216, the administrator may create a plurality of workflow states for the project via user interface 106 or 136, as shown in FIG. 3I. Each workflow state may be associated with a particular step in an application packaging job. For example, workflow states for an application packaging job and/or project may include any one or more of the following:
Initial (e.g., when a job is initially submitted by a customer);
With Discovery (e.g., a step in a workflow in which a discovery engineer determines the compatibility of an application; be packaged with a customer's existing platform, hardware, and or software; determines the obsolescence of the application to be packaged; or determines whether an application is relevant to the customer requesting the application packaging job);
Raised (e.g., when an application packaging job has been approved or “raised” by the discovery engineer);
With Packager (e.g., when a raised application packaging job has been assigned to a packaging engineer);
For QA (e.g., when an application packaging job has been completed by the packager and is ready for quality assurance review);
With QA (e.g., when an application packaging job has been assigned to a quality assurance engineer);
With Gatekeeper (e.g., an interface between Quality Assurance and Verification; users/assignees at this workflow state may be highly technical project managers);
For Verification (e.g., when an application packaging job is ready for verification of the installation package);
With Verification (e.g., when the application has been assigned to a verification engineer);
For UAT (e.g., when an application has completed verification and is ready for user acceptance testing);
With UAT (e.g., when an application has been assigned to a user acceptance tester);
With Deployment (e.g., when an application is ready for deployment and/or is being deployed);
Accepted (e.g., when an installation package has been accepted by a customer);
Closed (e.g., when an installation package has been accepted by a customer and the job is closed); and
Withdrawn/Abandoned (e.g., when a application packaging job has been terminated prior to completion).

After the workflow states have been created, the administrator may configure variables and parameters associated with each workflow state (e.g., in steps 218-234 below). For example, in the screen shown in FIG. 3I, the administrator may click on “Edit” in the row for “Raised”, which may bring up the screen shown in FIG. 3J.

At step 218, the administrator may associate a state type to each of the plurality of workflow states. For example, as shown in FIG. 3J, the a state type of “Raised” may be associated with the workflow state “Raised.” In certain embodiments, a state type of “Raised” may indicate that a job has entered an engineering process. Other possible state types may include any one or more of the following:
Initial (e.g., the application packaging job has not entered the engineering process);
Closed (e.g., the job has been closed);
Withdrawn (e.g., the job has been withdrawn);
Abandoned (e.g., the job has been abandoned); and
Normal (e.g., to designate a state that is not one of the other state types).

At step 220, the administrator may associate a cost schedule with at least one of the workflow states via user interface 106 or 136. For example, as shown in FIG. 3K, an administrator may select an option that a state in an application packaging job will not be charged to a customer, an option that the state is to be charged at a time and materials cost per hours, or that the state will be charged at a total fixed cost based on the complexity levels set at step 212.

At step 222, the administrator may associate at least one action with each of the workflow states via user interface 106 or 136. For example, FIG. 3L depicts a number of actions that may be associated with a workflow state of “Raised.” Among the possible actions associated with the workflow state “Raised” may be “Assign to Packager” (e.g., a manager selects an action to assign a job to a packaging engineer), “Return to Customer” (e.g., a manager selects an action to return a job to the customer), and “Return to Discovery” (e.g., a manager selects an action to return a job to a discovery engineer for further investigation).

At step 224, the administrator may associate a target state with each action via user interface 106 or 136. Thus, the action may define a transition from one workflow state to a target state. For example, for the action “Assign to Packager,” the associated target state may be selected as “With Packager,” as shown in FIG. 3M.

At step 226, the administrator may also associate an assignee type with each action via user interface 106 or 136. For example, as shown in FIG. 3M, an administrator may associate an assignee type of “Packager” to the action “Assign to Packager.” Accordingly, if the action “Assign to Packager” is selected during an application packaging job, the application packaging job will be assigned to an assignee with an assignee type of “Packager”).

At step 228, the administrator may also associate an action type with each action. The associated action type may allow particular actions to be identified as a milestone with regards to quality control. For example, an action type of “Pass” may be associated with an action of “Assign to Gatekeeper”, as it indicates quality assurance approval. On the other hand, an action type of “Fail” may be associated with an action of “Return to Packager”, as it may indicate quality assurance failure.

At step 230, the administrator may associate a script with one or more actions via user interface 106 or 136. The associated script for each action may be operable, when executed, to perform an automated task in connection with the action. For example, as shown in FIG. 3M, the administrator may associate a script to “Create Job Packaging Folder” with the action “Assign to Packager.” Thus, during an application packaging job, when the action “Assign to Packager” is selected, a script may run to create the job packaging folder. In some instances, a script associated with a particular action may be a “template” or predefined “canned” script. In other instances, a script associated with a particular action may be a customized script.

At step 232, the administrator, via user interface 106 or 136, may configure for each action user interface components that an assignee may edit and/or must enter while using the packaging application 110 and/or accessing the packaging application 110 via client application 140. For example, as shown in FIG. 3N, for the action “Assign to Packager,” the administrator has selected that the data field “Assigned To” is editable and required to be entered when the action is selected during an application packaging job.

At step 234, the administrator may associate roles with each action via user interface 106 or 136, the roles defining the assignee types that may perform the particular action. For example, as shown in FIG. 3O, an administrator may select that only those with an assignee type of “Manager” may be allowed to perform the action “Assign to Packager.”

At step 236, the administrator may request verification of the workflow, and packaging application 110 may verify the created workflow. For example, packaging application 110 may verify that every non-terminal workflow state (e.g., those with state type of Initial, Raised, or Normal) has at least one action associated therewith.

At 238, the various settings and parameters set by the administrator in relation to the project may be stored in database 127.

Although FIGS. 2A and 2B disclose a particular number of steps to be taken with respect to method 200, it is understood that method 200 may be executed with greater or fewer steps than those depicted in FIGS. 2A and 2B. In addition, although FIGS. 2A and 2B disclose a certain order of steps to be taken with respect to method 200, the steps comprising method 200 may be completed in any suitable order. Method 200 may be implemented using information handling system 200 or any other system operable to implement method 200. In certain embodiments, method 200 may be implemented partially or fully in software embodied in tangible computer-readable media.

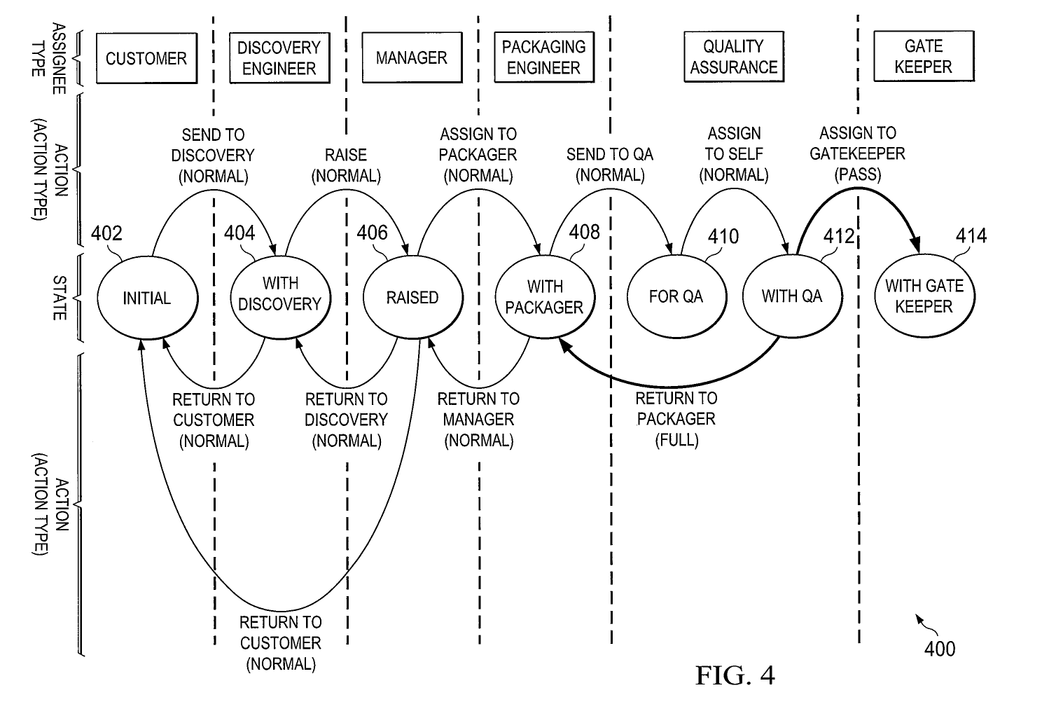

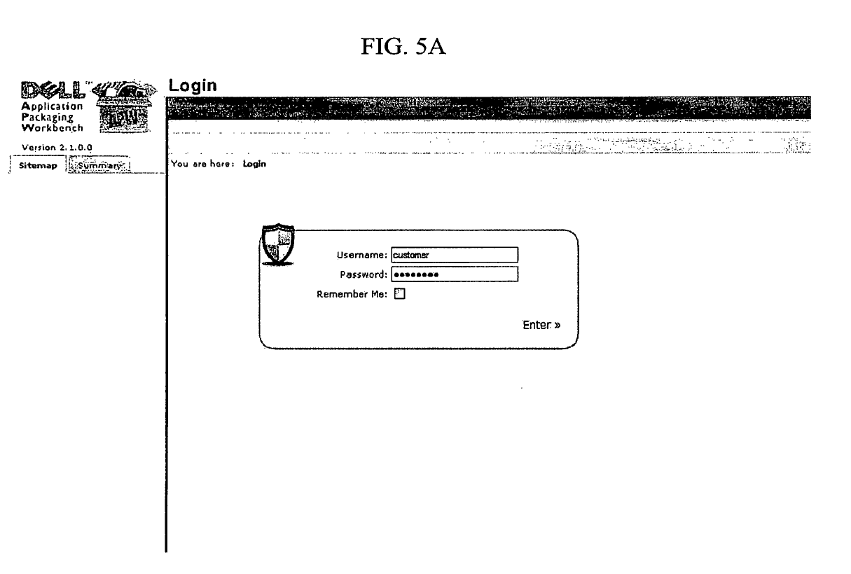

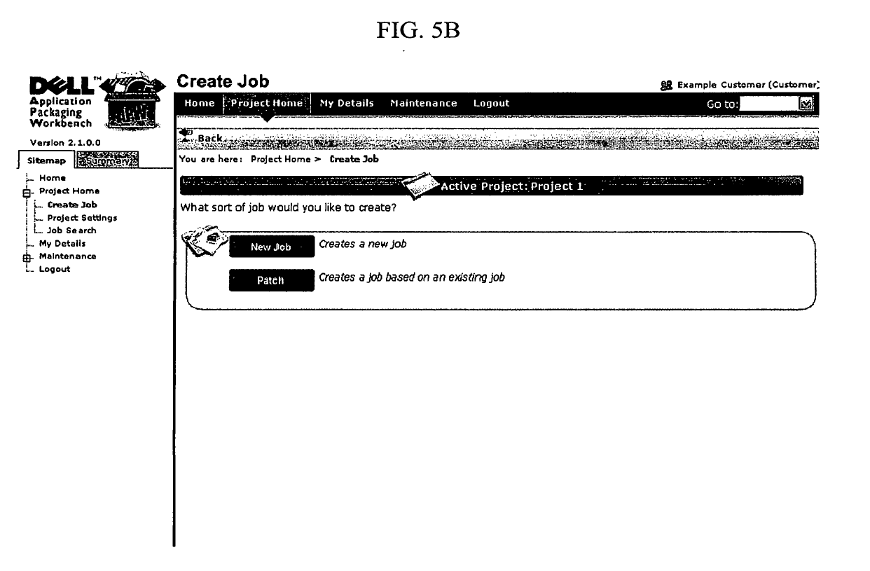

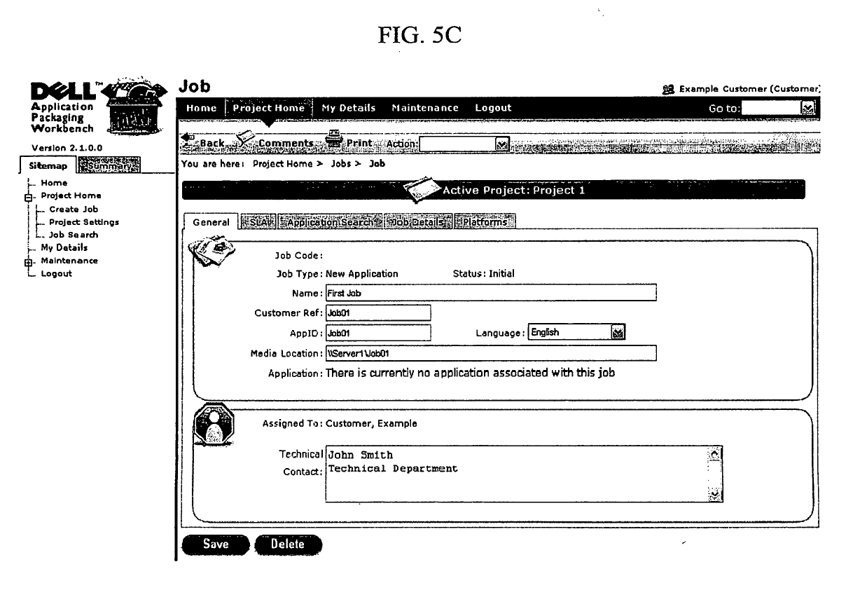

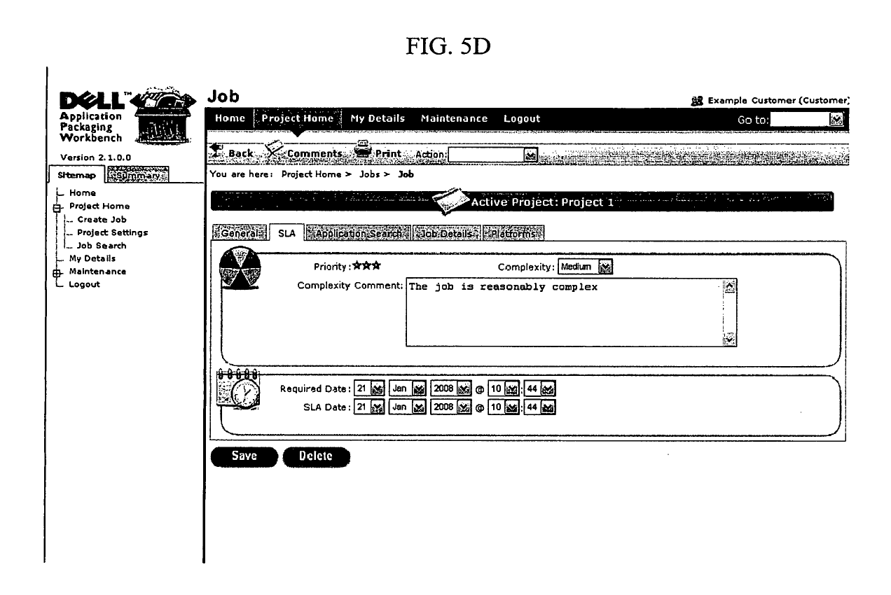

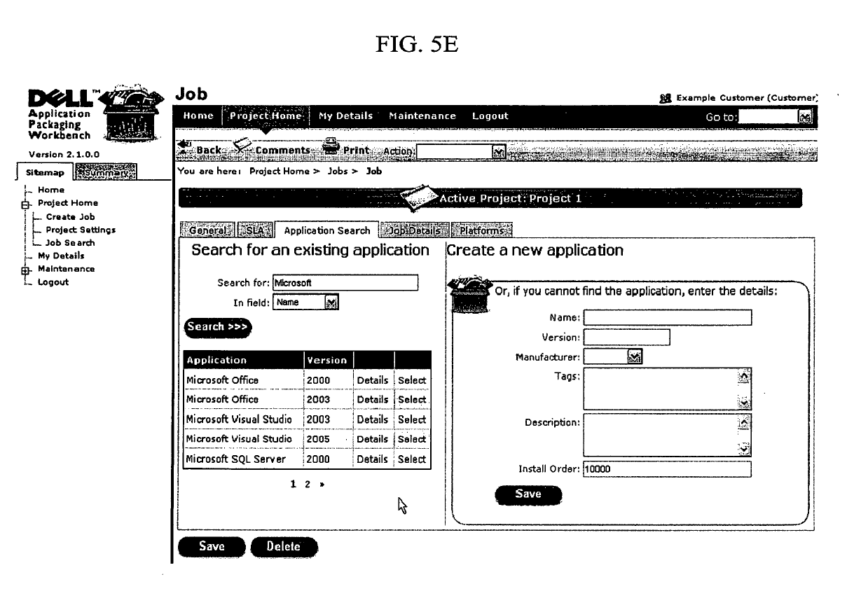

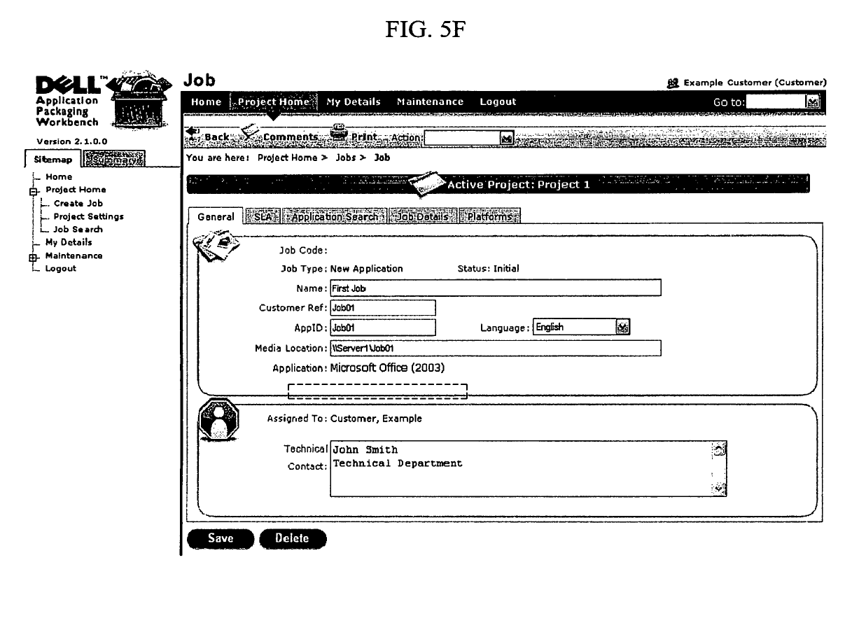

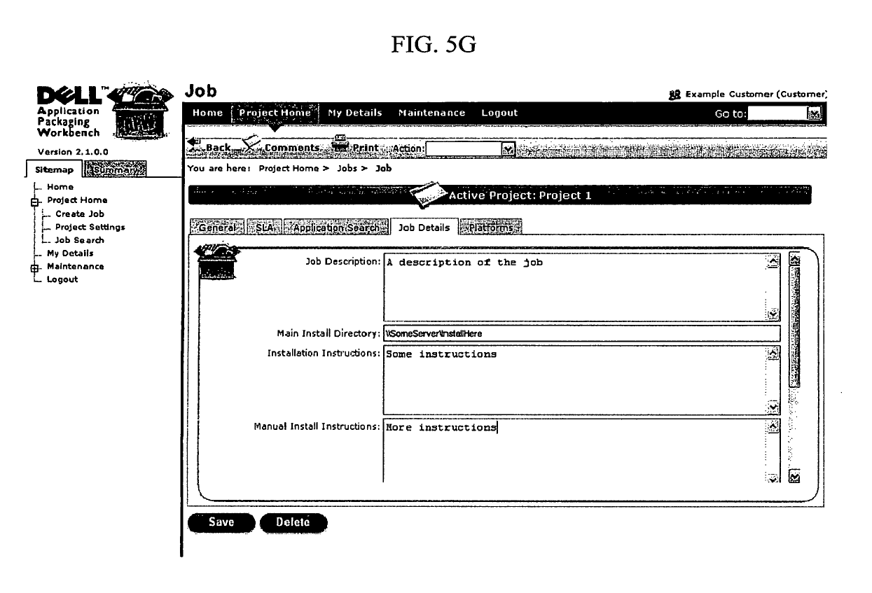

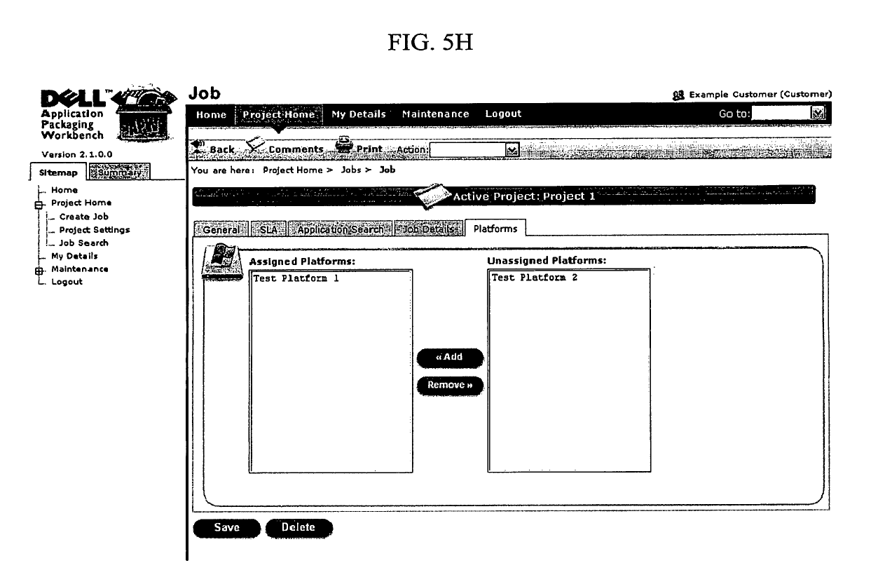

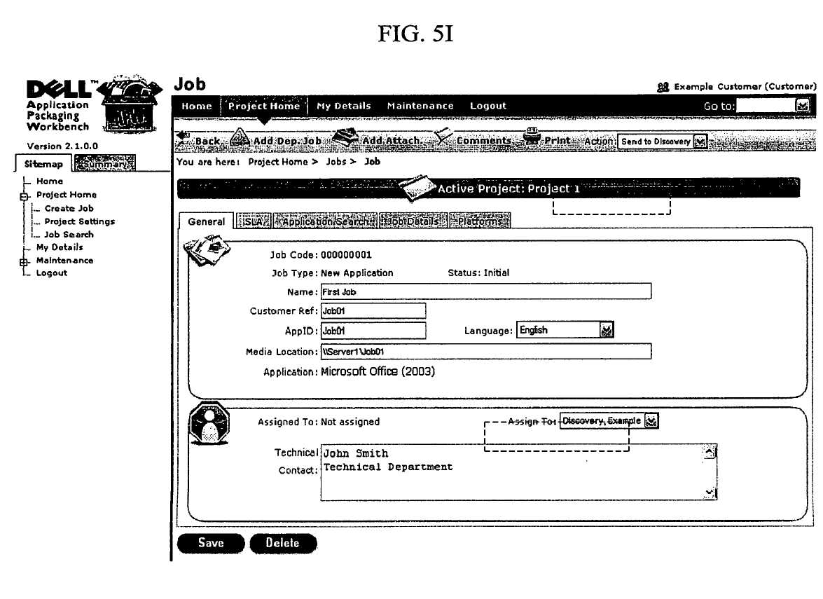

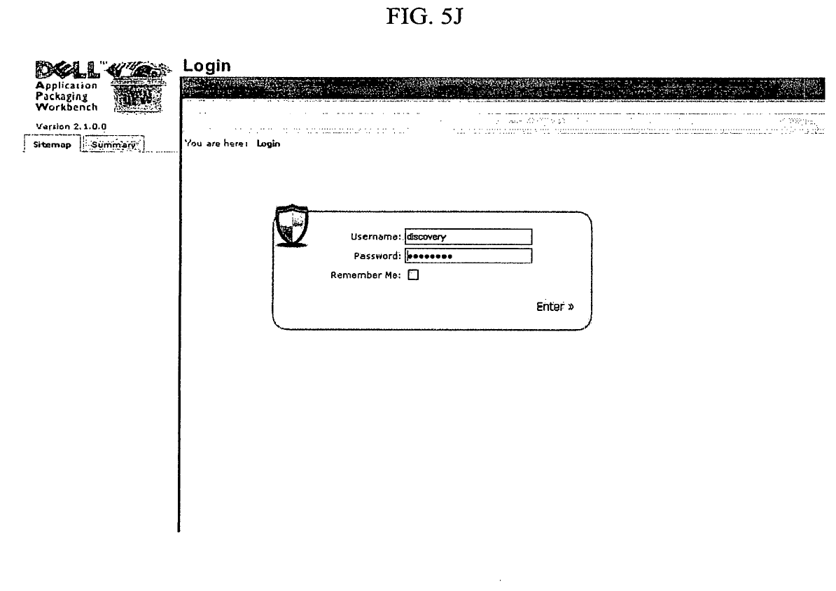

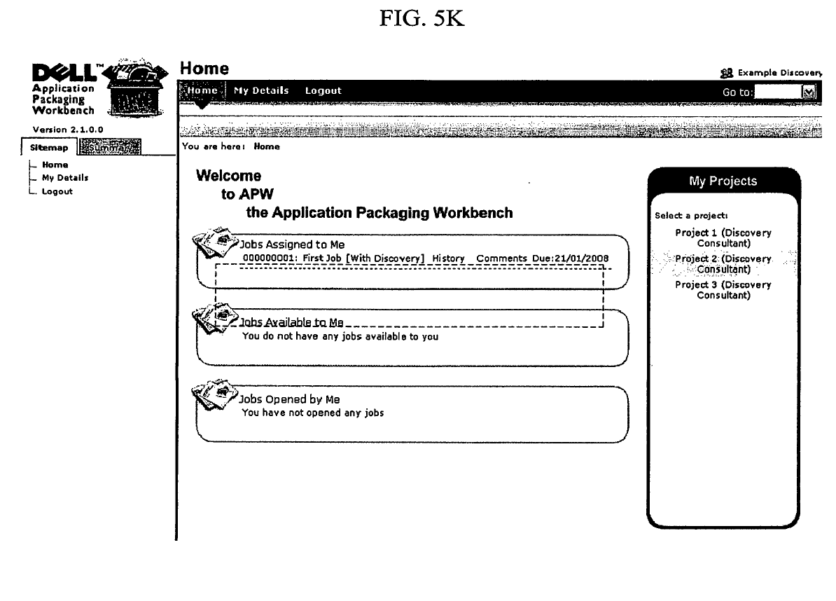

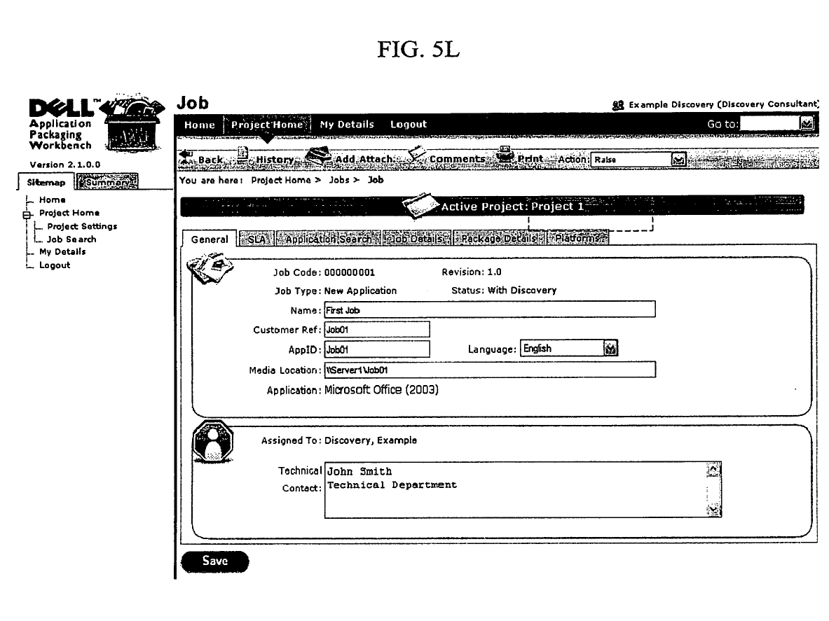

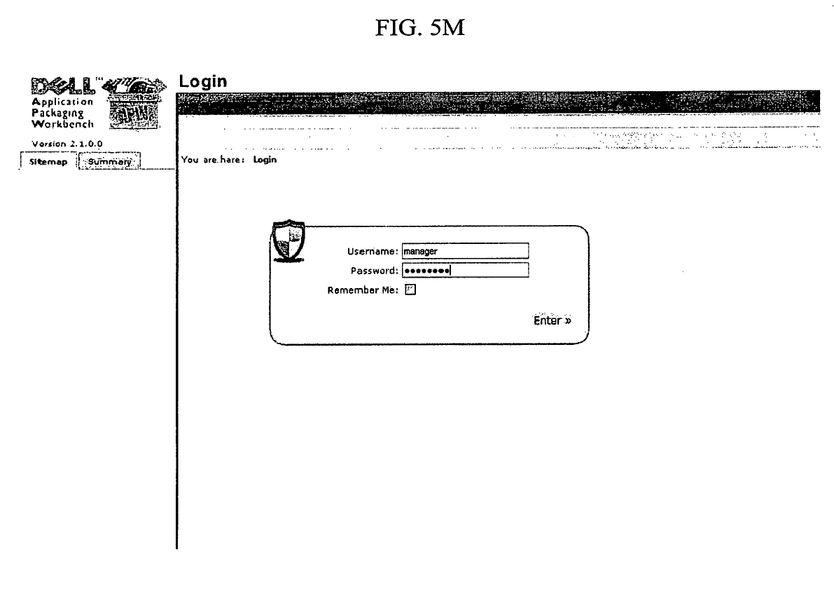

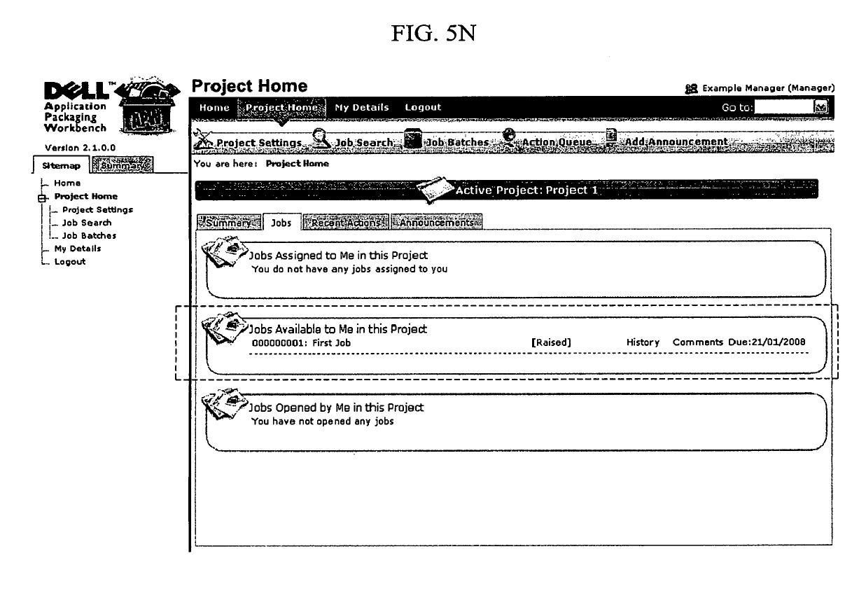

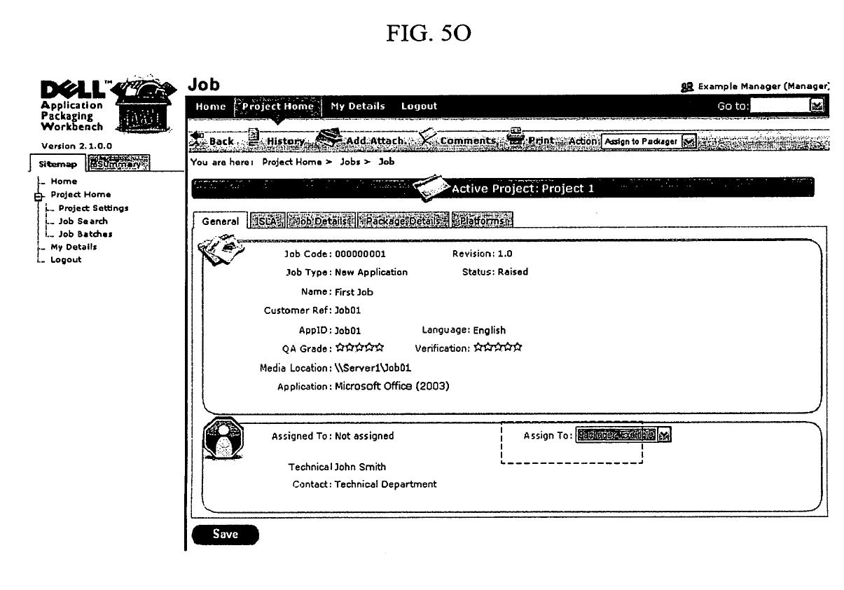

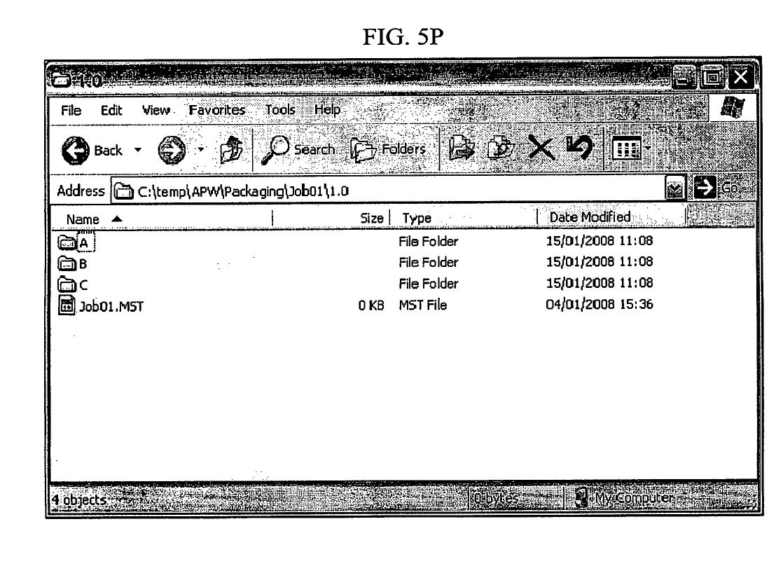

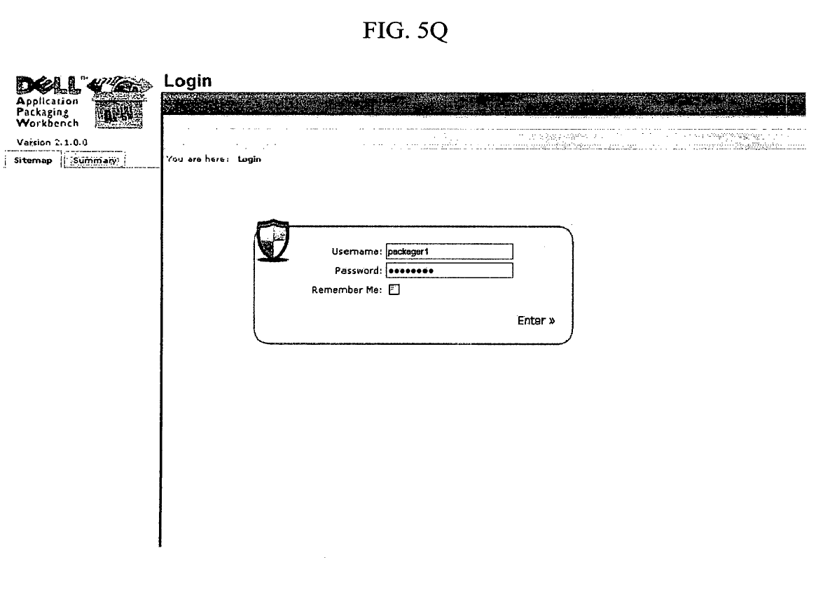

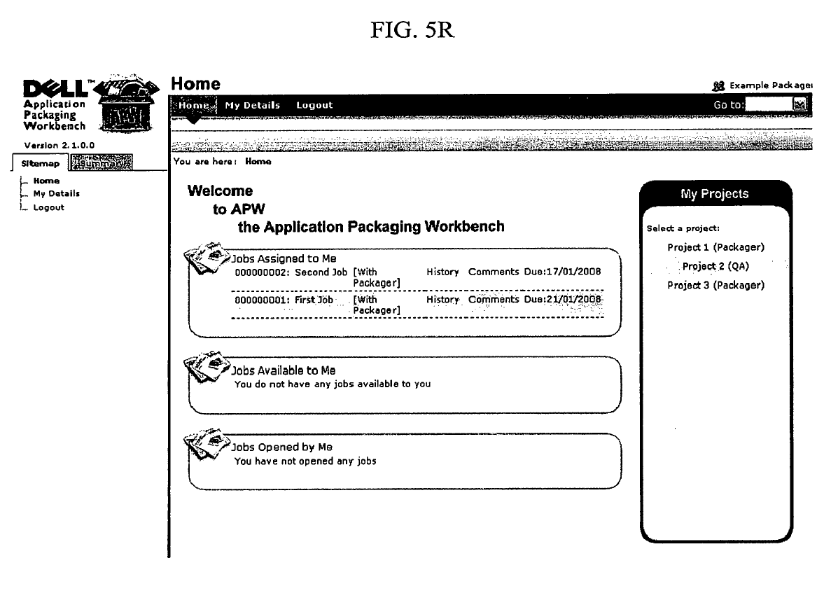

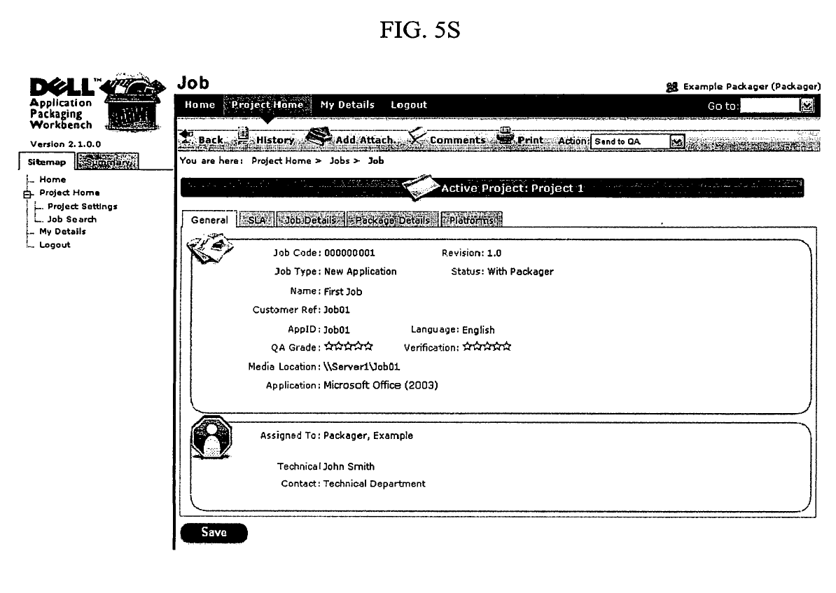

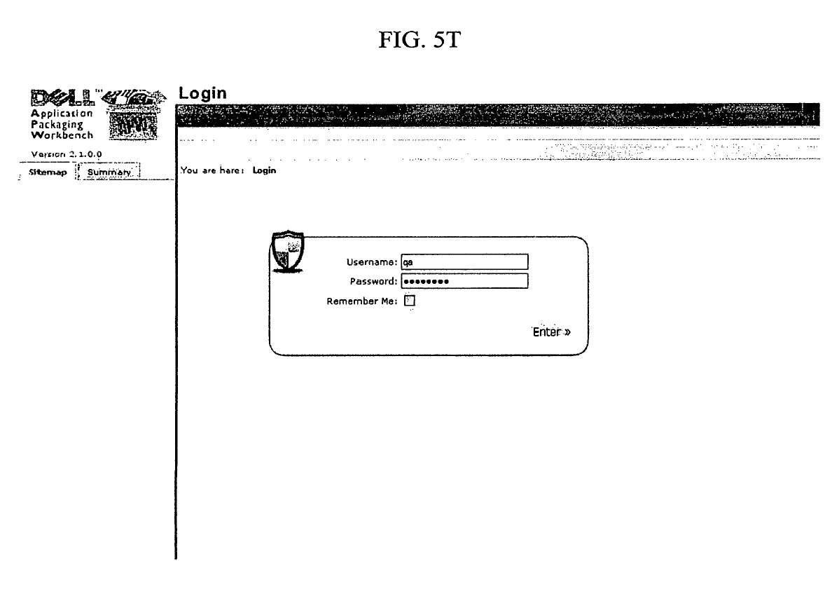

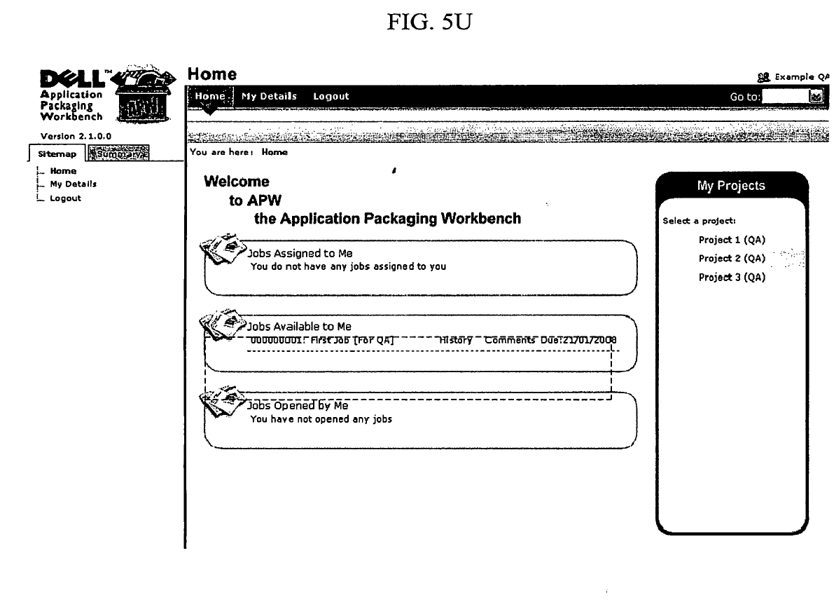

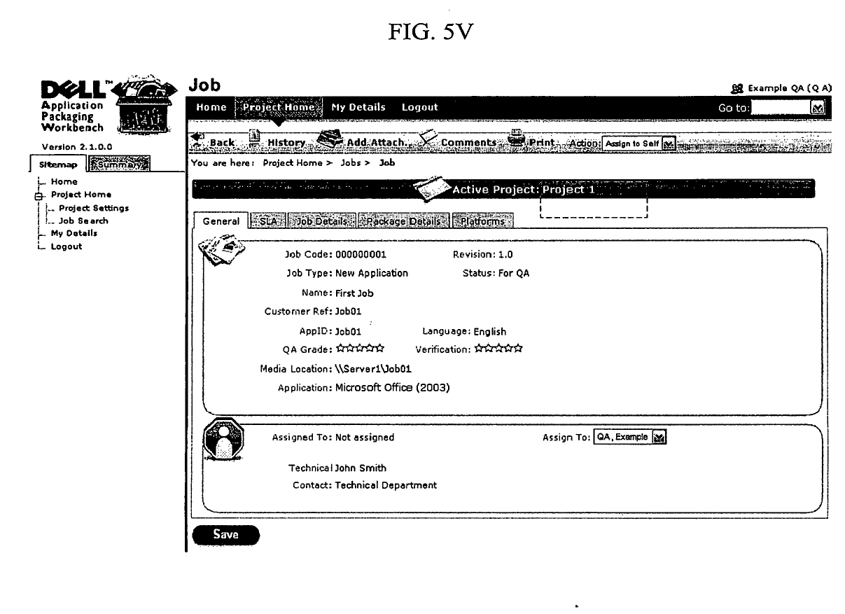

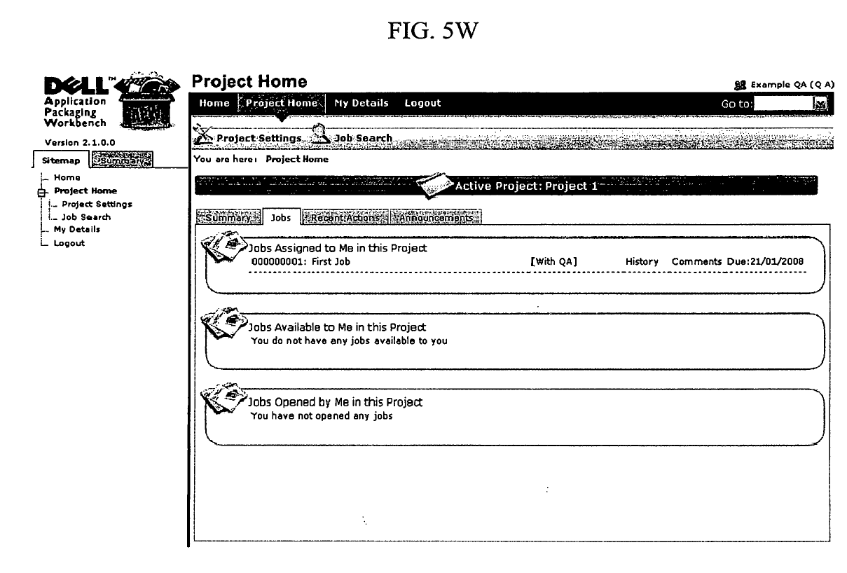

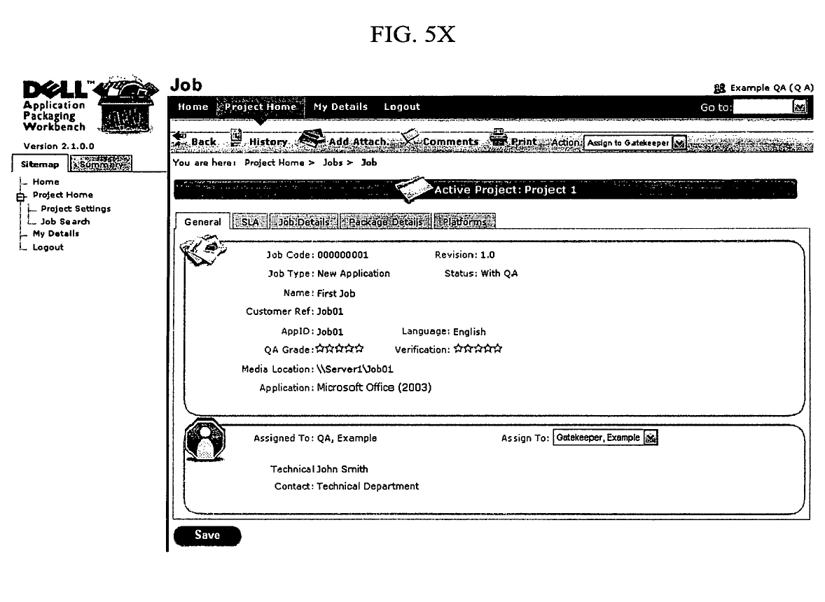

FIG. 4 illustrates a state diagram 400 for a portion of an example workflow for an application packaging job generated using method 200 depicted in FIGS. 2A and 2B, in accordance with the present disclosure. FIGS. 5A-5X illustrate example user interface screens displayed by packaging application 110 at user interface 106, or displayed by packaging application 110 via client application 140 at user interface 126, during the application packaging job depicted in FIG. 4, in accordance with the present disclosure.

An application packaging job may be initiated by a customer. For example, as shown in FIG. 5A, a customer may login to packaging application 110 by using client application 140 at one of clients 132. After logging in, the customer may create a new job, for example, by clicking on the appropriate link and/or button shown in FIG. 5B. At this point, the application packaging job may be considered to be in the workflow state “Initial” indicated by element 402. The customer may also enter general information regarding the job (e.g., job name, media location paths) as shown in FIG. 5C, and/or information regarding the complexity of the job (e.g., as shown in FIG. 5D). The customer may also select the application to be packaged (see FIGS. 5E and 5F), enter installation instructions (see FIG. 5G), and/or enter information regarding the platform associated with the job (see FIG. 5H). After adequate information regarding the application packaging job has been entered, the customer may choose the action “Send to Discovery” and may assign to discovery engineer “Example Discovery” as shown in FIG. 5I.

After the customer has submitted the job to the discovery engineer, the job may be considered to be in the workflow state “With Discovery” indicated by element 404. Generally speaking, the discovery workflow state may be implemented to further research the application to be packaged for its suitability for application packaging. This may be necessary because large organizations may have thousands of applications, some of which might be little-used or redundant. In addition, an application might have similar functionality as another product used elsewhere in the organization. In other cases, additional information about the application to be packaged might need to be gathered. For example, the application might not be compatible with the target operating system or platform.

A discovery engineer may login to packaging application 110 by using client application 140 at one of clients 132, as shown in FIG. 5J. After logging in, the discovery engineer may select a job assigned to the discovery engineer, for example, by clicking on the appropriate link and/or button shown in FIG. 5K. After performing research regarding the application to be packaged, the discovery engineer may choose the action “Raise” to raise the job, or, if further information is needed from the customer, may choose the action to “Return to Customer.” FIG. 5L depicts a selection of the action “Raise” (as shown in the dashed box) by the discovery engineer.

After the discovery engineer has raised the job, the job may be considered to be in the workflow state “Raised” indicated by element 406. A manager may login to packaging application 110 by using client application 140 at one of clients 132, as shown in FIG. 5M. After logging in, the manager may select a job associated with a project to which the manager is assigned, for example, by clicking on the appropriate link and/or button shown in FIG. 5N. The manager may choose the action “Assign to Packager” to assign the job to a packaging engineer for packaging (as shown in the dashed box of FIG. 50), may choose the action “Return to Discovery” to return the job to the discovery engineer (for example, if the manager determined more research is needed in discovery), or may choose the action to “Return to Customer” if the manager determines that more information is needed from the customer. FIG. 50 depicts a selection of the action “Assign to Packager” with an assignment to the packaging engineer “Example Packager” by the manager. In certain embodiments, the assignment of a job to a packaging engineer may initiate the execution of a script. For example, a script may be operable to create a folder structure and/or an installation transform file (e.g., an MST file), as shown in FIG. 5P.

After the manager has assigned the job to a packaging engineer, the job may be considered to be in the workflow state “With Packager” indicated by element 408. A packaging engineer may login to packaging application 110 by using client application 140 at one of clients 132 as shown in FIG. 5Q. After logging in, the packaging engineer may select a job assigned to the packaging engineer, for example, by clicking on the appropriate link and/or button shown in FIG. 5R. After completing the packaging process, the packaging engineer may choose the action “Send to QA” to send the job to quality assurance, as shown in FIG. 5S. On the other hand, the packaging engineer may in some cases choose the action “Return to Manager” to return the job to the manager (for example, if the packaging engineer required more information to complete the packaging job).

After the packaging engineer has sent the job to quality assurance, the job may be considered to be in the workflow state “For QA” indicated by element 410. A quality assurance engineer may login into to packaging application 110 by using client application 140 at one of clients 132, as shown in FIG. 5T. After logging in, the quality assurance engineer may select a job available to the quality assurance engineer, for example, by clicking on the appropriate link and/or button shown in FIG. 5U and assign the job to himself or herself as shown in FIG. 5V. The job may then be considered to be in workflow state “With QA” indicated by element 412. The quality assurance engineer may select a the same job or a different job assigned to the quality assurance engineer, for example, by clicking on the appropriate link and/or button shown in FIG. 5W. After evaluating the packaging job, the quality assurance engineer may assign a quality assurance grade, as shown in FIG. 5X. If the quality assurance grade is a passing grade, the action “Assign to Gatekeeper” may be selected and the job may proceed to the workflow state “With Gatekeeper” indicated by element 414. On the other hand, if the quality assurance grade is a failing grade, the action “Return to Packager” may be selected.

As mentioned above, FIG. 4 depicts only a portion of an example workflow. Accordingly, the workflow depicted in FIG. 4 may have additional workflow states beyond the “With Gatekeeper” state (e.g., “With Verification,” “For User Acceptance Testing,” “With User Acceptance Testing,” “With Deployment”). In addition, because the workflow shown in FIG. 4 is an example, many other different workflows could be created using system 100 and/or method 200.

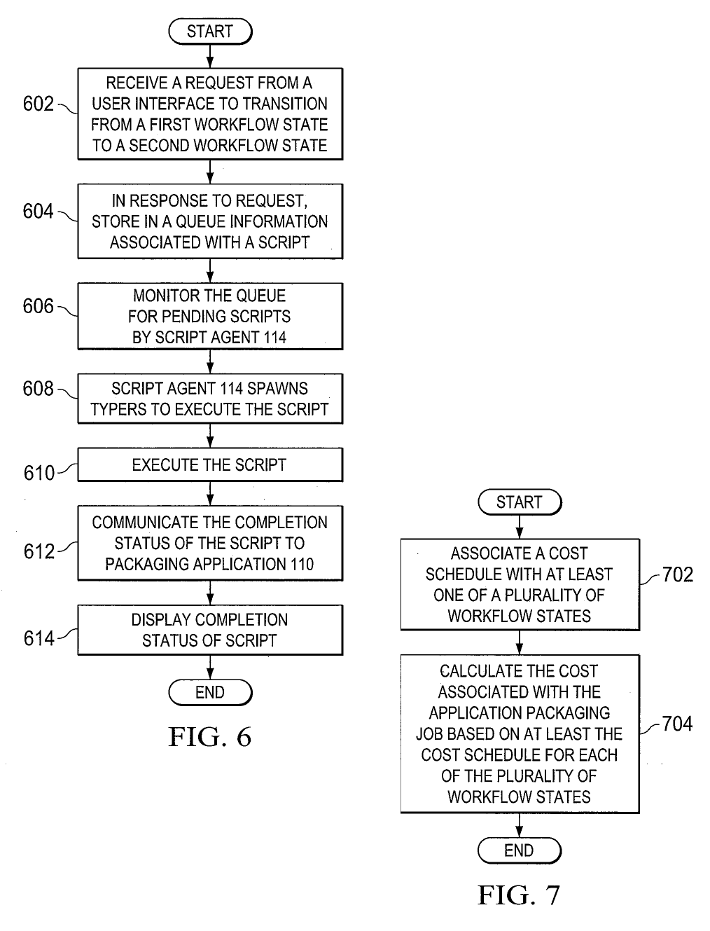

FIG. 6 illustrates a flow chart of an example method 600 for automating tasks associated with an application packaging job, in accordance with the present disclosure. According to one embodiment, method 600 preferably begins at step 602. As noted above, teachings of the present disclosure may be implemented in a variety of configurations of system 100. As such, the preferred initialization point for method 600 and the order of the steps 602-614 comprising method 600 may depend on the implementation chosen.

At step 602, packaging application 110 may receive a request (e.g., via a client application 140) to transition from a first workflow state to a second workflow state (e.g., an “Assign to Packager” action that transitions from a workflow state of “Raised” to a workflow state of “With Packager”). At step 604, in response to the request to transition, packaging application may store in a queue (e.g., a queue stored in database 127) information associated with a script. The script may include instructions for performing an automated task related to the application packaging job. For example, the script may be operable to automatically create one or more file folders for a packaging job, automatically create an installation file for a packaging job, automatically create documentation for the application packaging job, and/or automatically perform versioning the application packaging job. “Versioning” as used in this disclosure refers to archiving a current set of packaging folder and files as a previous version, creating a new version populated with the recently-archived folder contents and/or storing label or other indicia of version number. In certain embodiments, the script may be written in the C# programming language.

At step 606, script agent 114 may monitor the queue for pending scripts. At step 608, script agent may detect the existence of a pending script in the queue, and spawn a thread to execute the script. At step 610, script agent 114 may execute the script. At step 612, script agent 114 may communicate to packaging application 110 the completion status of the script. At step 614, packaging application 110 may display the completion status of the script via user interface 106 or user interface 126. After completion of step 614, method 600 may end.

Although FIG. 6 discloses a particular number of steps to be taken with respect to method 600, it is understood that method 600 may be executed with greater or fewer steps than those depicted in FIG. 6. In addition, although FIG. 6 discloses a certain order of steps to be taken with respect to method 600, the steps comprising method 600 may be completed in any suitable order. Method 600 may be implemented using information handling system 600 or any other system operable to implement method 600. In certain embodiments, method 600 may be implemented partially or fully in software embodied in tangible computer-readable media.

Using a method identical or similar to method 600, system 100 may allow the execution of scripts to perform automated tasks, which may reduce time needed to complete a packaging job. In addition, method 600 allows such scripts to run as a process separate from the packaging application 110, thus reducing the processing burden on packaging application 110.

FIG. 7 illustrates a flow chart of an example method 700 for automating calculating costs associated with an application packaging job, in accordance with the present disclosure. FIG. 7 illustrates a flow chart of an example method 700 for automating tasks associated with an application packaging job, in accordance with the present disclosure. According to one embodiment, method 700 preferably begins at step 702. As noted above, teachings of the present disclosure may be implemented in a variety of configurations of system 100.

Although FIG. 7 discloses a particular number of steps to be taken with respect to method 700, it is understood that method 700 may be executed with greater or fewer steps than those depicted in FIG. 7. In addition, although FIG. 7 discloses a certain order of steps to be taken with respect to method 700, the steps comprising method 700 may be completed in any suitable order.

At step 702, a user may associate a cost schedule with at least one of a plurality of workflow states (e.g., as depicted in step 220 of method 200). The cost schedule for a particular workflow state may be an hourly rate for completion of the state or a complexity associated with the application packaging job. In certain embodiments, one or more states of an application packaging job may have no cost associated with it (e.g., such states are not charged).

At step 704, packaging application 110 may calculate the cost associated with the application packaging job based at least on the cost schedule for each of the plurality of workflow states (e.g., an aggregate total of the cost associated with each individual workflow state). After execution of step 704, method 700 may end.

Method 700 may be implemented using information handling system 700 or any other system operable to implement method 700. In certain embodiments, method 700 may be implemented partially or fully in software embodied in tangible computer-readable media.

Although the present disclosure has been described in detail, it should be understood that various changes, substitutions, and alterations can be made hereto without departing from the spirit and the scope of the invention as defined by the appended claims.

What is claimed is:

1. A method for automating calculation of costs associated with an application packaging job, comprising:
receiving input from a user interface by a packaging application configured to manage an application packaging job;
creating a plurality of workflow states based on at least the received input, each workflow state associated with a particular step in the application packaging job;
associating a cost schedule with at least one of the workflow states, wherein the cost schedule is based on one of an hourly rate for completion of the state and a complexity associated with the application packaging job; and
calculating the cost associated with the application packaging job based on at least the cost schedule for each of the plurality of workflow states.

2. A method according to claim 1, wherein the plurality of workflow states include at least one of a state associated with compatibility determination of an application to be packaged, a state associated with obsolescence determination of the application to be packaged, a state associated with relevancy determination of the application to be packaged, a state associated with packaging of the application, a state associated with quality assurance of an application package, and a state associated with verification of the installation of a packaged application.

3. An information handling system, comprising:
a processor;
a memory communicatively coupled to the processor; and
a tangible computer-readable medium communicatively coupled to the processor, the tangible computer-readable medium having stored thereon a program of instructions operable to, when executed by the processor:
receive input from a user interface;
create a plurality of workflow states based on at least input from a user based on at least the received input, each workflow state associated with a particular step in the application packaging job;
associate a cost schedule with at least one of the workflow states, wherein the cost schedule is based on one of an hourly rate for completion of the state and a complexity associated with the application packaging job; and
calculate the cost associated with the application packaging job based on at least the cost schedule for each of the plurality of workflow states.

4. An information handling system according to claim 1, wherein the plurality of workflow states include at least one of a state associated with compatibility determination of an application to be packaged, a state associated with obsolescence determination of the application to be packaged, a state associated with relevancy determination of the application to be packaged, a state associated with packaging of the application, a state associated with quality assurance of an application package, and a state associated with verification of the installation of a packaged application.

5. A program of instructions embodied on a tangible computer-readable medium, the program of instructions operable to, when executed:
receive input from a user interface;
create a plurality of workflow states based on at least input from a user based on at least the received input, each workflow state associated with a particular step in the application packaging job;
associate a cost schedule with at least one of the workflow states, wherein the cost schedule is based on one of an hourly rate for completion of the state and a complexity associated with the application packaging job; and
calculate the cost associated with the application packaging job based on at least the cost schedule for each of the plurality of workflow states.

6. A program of instructions according to claim 5, wherein the plurality of workflow states include at least one of a state associated with compatibility determination of an application to be packaged, a state associated with obsolescence determination of the application to be packaged, a state associated with relevancy determination of the application to be packaged, a state associated with packaging of the application, a state associated with quality assurance of an application package, and a state associated with verification of the installation of a packaged application.
